(19) United States
(12) Patent Application Publication
(10) Pub. No.: US 2024/0117246 A1
(43) Pub. Date: Apr. 11, 2024

(54) A3BX5, A2BX4, ABX3, AND AX HALIDE SCINTILLATORS DOPED WITH TRANSITION METAL IONS

(71) Applicant: University of Tennessee Research Foundation, Knoxville, TN (US)

(72) Inventors: Luis Stand Stracuzzi, Knoxville, TN (US); Daniel Joseph Rutstrom, Knoxville, TN (US); Mariya Zhuravleva, Knoxville, TN (US); Charles L. Melcher, Oak Ridge, TN (US)

(73) Assignee: University of Tennessee Research Foundation, Knoxville, TN (US)

(21) Appl. No.: 18/369,468

(22) Filed: Sep. 18, 2023

Related U.S. Application Data
(60) Provisional application No. 63/451,687, filed on Mar. 13, 2023.
(60) Provisional application No. 63/407,377, filed on Sep. 16, 2022.

(51) Int. Cl. C09K 11/62; G01T 1/20

(52) U.S. Cl. CPC C09K 11/626; G01T 1/2006

(57) ABSTRACT

Doped halide scintillator materials of the formulas A₂B₁-iX₄:Dᵢ, AB₁₋ᵢX₂:Dⁱ, A₁₋ᵢX:Dⁱ, and A₃B₁₋ᵢX₅:Dᵢ, wherein A is one or more monovalent cations (e.g., Tl, In, Li, Na, K, Rb, or Cs); B is one or more divalent cations (e.g., Be, Mg, Ca, Sr, Ba, Zn, Cd, and Hg), X is one or more halide, and D is one or more transition or post-transition metal dopant ions (e.g., Zn, Cd, Hg, Cu, Mn, and Ga) are described. Also described are non-doped halide scintillator materials of the formula A₃BX₅, related radiation detectors, methods of detecting high energy radiation, and methods of preparing the scintillator materials.

### RELATED APPLICATIONS

The presently disclosed subject matter is based on and claims the benefit of U.S. Provisional Patent Application Ser. No. 63/407,377, filed Sep. 16, 2022, and U.S. Provisional Patent Application Ser. No. 63/451,687, filed on Mar. 13, 2023; the disclosure of each of which is incorporated herein by reference in its entirety.

### GOVERNMENT INTEREST

This invention was made with government support under contract DE-NE0000094 awarded by the Department of Energy. The government has certain rights in the invention.

### PARTIES TO A JOINT RESEARCH AGREEMENT

The subject matter disclosed herein was made by, on behalf of, and/or in connection with one or more of the following parties to a joint research agreement: Siemens Medical Solutions USA, Inc., and The University of Tennessee. The agreement was in effect on and before the effective filing date of the presently disclosed subject matter, and the presently disclosed subject matter was made as a result of activities undertaken within the scope of the agreement.

### TECHNICAL FIELD

The presently disclosed subject matter relates to A₃BX₅, A₂BX₄, ABX₃, and AX halide scintillators (wherein A is one or more monovalent ions, B is one or more divalent ions, and X is one or more halide) doped with transition or post-transition metal ions, e.g., Zn, Cd, Hg, Cu, Mn, and/or Ga ions. The presently disclosed subject matter further relates to non-doped A₃BX₅ scintillators. The presently disclosed subject matter also relates to radiation detectors comprising the scintillators, to methods of using the detectors, and to methods of preparing the scintillators.

### Abbreviations

%=percentage
° C.=degrees Celsius
μs=microseconds
a.u.=arbitrary units
Ba=barium
Be=beryllium
Br=bromide
Ca=calcium
Cd=cadmium
Cl=chloride
Cs=cesium
cm=centimeter
CT=computed tomography
Cu=copper
CVL=core valence luminescence
F=fluoride
Ga=gallium
Hg=mercury
HEP=high energy physics
I=iodide
In=indium
K=potassium
keV=kiloelectron volts
kV=kilovolt
Li=lithium
LY=light yield
mA=milliampere
MeV=megaelectronvolt
Mg=magnesium
mm=millimeter
Mn=manganese
mol=mole
Na=sodium
nm=nanometer
ns=nanoseconds
PET=positron emission tomography
ph=photons
PMT=photomultiplier tube
QE (or Q.E.)=quantum efficiency
Rb=rubidium
SPE=single photoelectron
Sr=strontium
TI=thallium
TOF=time-of-flight
XRD=x-ray diffraction
Zn=zinc

### BACKGROUND

Scintillator materials, which emit light pulses in response to impinging radiation, such as X-rays, gamma rays, and thermal neutron radiation, are used in detectors that have a wide range of applications in medical imaging, particle physics, geological exploration, security and other related areas. Considerations in selecting scintillator materials typically include, but are not limited to, luminosity, decay time, energy resolution, and emission wavelength.

Inorganic scintillators that exhibit core valence luminescence (CVL), also referred to as cross luminescence, are attractive for use in fast timing radiation detection applications due to their characteristic decay times on the order of a few nanoseconds or less. These applications include, but are not limited to, time-of-flight positron emission tomography (TOF-PET), high energy physics (HEP) experiments, and hard X-ray imaging. Several CsCl-based CVL scintillators have been reported in literature including CsCl [1], as well as ternary compounds comprising CsCl, such as CsMgCl₃ [2-4], CsCaCl₃ [4,5], CsSrCl₃ [3], Cs₂BaCl₄ [6], and Cs₂ZnCl₄ [7-9]. Improving the properties (for example light yield, decay time, and/or timing resolution) of such materials, or similar halide scintillators, could have a direct impact on the ultimate performance of detection systems like those used in the aforementioned applications.

Accordingly, there is an ongoing need to develop additional scintillator materials, e.g., additional alkali and/or alkaline earth metal halide-based scintillators that exhibit CVL, with improved properties for particular applications.

### SUMMARY

In some embodiments, the presently disclosed subject matter provides a scintillator material comprising a composition of one of Formulas (I), (II), (III) or (IV): A₂B₁₋ᵢX₄:Dᵢ, (I), AB₁₋ᵢX₃:Dᵢ, (II), A₁₋ᵢX:Dᵢ, (III), or A₃B₁₋ᵢX₅:Dᵢ, (IV); wherein: 0.0001≤i≤0.9999; A is one or more monovalent cations selected from the group comprising Tl, In, Li, Na, K, Rb, and Cs; B is one or more divalent cations selected from the group comprising Be, Mg, Ca, Sr, Ba, Zn, Cd, and Hg; X is one or more halides selected from the group comprising F, Cl, Br, and I, subject to the proviso that when the scintillator material comprises a composition of Formula (III), X comprises at least one halide of the group consisting of F, Cl, and Br; and D is one or more dopant ions selected from the group comprising Zn, Cd, Hg, Cu, Mn, and Ga, subject to the proviso that D is not the same as B.

In some embodiments, the scintillator material comprises a composition of Formula (I): A₂B₁₋ᵢX₄:Dᵢ, (I), wherein: 0.0001≤i≤0.9999; A is one or more monovalent cations selected from the group comprising Tl, In, Li, Na, K, Rb, and Cs; B is one or more divalent cations selected from the group comprising Be, Mg, Ca, Sr, Ba, Zn, Cd, and Hg; X is one or more halides selected from the group comprising F, Cl, Br, and I; and D is one or more dopant ions selected from the group comprising Zn, Cd, Hg, Cu, Mn, and Ga, subject to the proviso that D is not the same as B.

In some embodiments, B comprises at least two different divalent cations, optionally wherein the composition of Formula (I) is a composition of Formula (Ia): A₂B′₁₋ᵢ₋ⱼB″ⱼX₄:Dᵢ (Ia), wherein: 0.0001≤i≤0.9999; 0.0001≤j≤0.9998; A is one or more monovalent cations selected from the group comprising Tl, In, Li, Na, K, Rb, and Cs; B′ and B″ are each a divalent cation selected from the group comprising Be, Mg, Ca, Sr, Ba, Zn, Cd, and Hg, optionally Be, Mg, Ca, Sr, and Ba, subject to the proviso that B′ and B″ are not the same; X is one or more halides selected from the group comprising F, Cl, Br, and I; and D is one or more dopant ions selected from the group comprising Zn, Cd, Hg, Cu, Mn, and Ga, subject to the proviso that D is not the same as B′ or B″.

In some embodiments, A comprises at least two different monovalent cations, optionally wherein the composition of Formula (I) is a composition of Formula (Ib): A′_{2-y}A″_{y}B₁₋ᵢX₄:Dᵢ (Ib), wherein: 0.0001≤i≤0.9999; 0<y<2; A′ and A″ are each a monovalent cation selected from the group comprising Tl, In, Li, Na, K, Rb, and Cs, subject to the proviso that A′ and A″ are not the same; B is one or more divalent cations selected from the group comprising Be, Mg, Ca, Sr, Ba, Zn, Cd, and Hg, optionally Be, Mg, Ca, Sr, and Ba; X is one or more halide selected from the group comprising F, Cl, Br, and I; and D is one or more dopant ions selected from the group comprising Zn, Cd, Hg, Cu, Mn, and Ga, subject to the proviso that D is not the same as B.

In some embodiments, X comprises at least two different halides, optionally wherein the composition of Formula (I) is a composition of Formula (Ic): A₂B₁₋ᵢX′_{4-w}X″_{w}:Dᵢ (Ic), wherein: 0.0001≤i≤0.9999; 0<w<4; A is one or more monovalent cations selected from the group comprising Tl, In, Li, Na, K, Rb, and Cs; B is one or more divalent cations selected from the group comprising Be, Mg, Ca, Sr, Ba, Zn, Cd, and Hg, optionally Be, Mg, Ca, Sr, and Ba; X′ and X″ are each a halide selected the group comprising F, Cl, Br, and I, subject to the proviso that X′ and X″ are not the same; and D is one or more dopant ions selected from the group comprising Zn, Cd, Hg, Cu, Mn, and Ga, subject to the proviso that D is not the same as B.

In some embodiments, A comprises at least two different monovalent cations, B comprises at least two different divalent cations, and X comprises at least two different halides, optionally wherein the composition of Formula (I) is a composition of Formula (Id): A′_{2-y}A″_{y}B′₁₋ᵢ₋ⱼB″ⱼX′_{4-w}X″_{w}:Dᵢ(Id), wherein: 0.0001≤i≤0.9999; 0.0001≤j≤0.9998; 0<y<2; 0<w<4; A′ and A″ are each a monovalent cation selected from the group comprising Tl, In, Li, Na, K, Rb, and Cs, subject to the proviso that A′ and A″ are not the same; B′ and B″ are each a divalent cation selected from the group comprising Be, Mg, Ca, Sr, Ba, Zn, Cd, and Hg, optionally Be, Mg, Ca, Sr, and Ba, subject to the proviso that B′ and B″ are not the same; X′ and X″ are each a halide selected the group comprising F, Cl, Br, and I, subject to the proviso that X′ and X″ are not the same; and D is one or more dopant ions selected from the group comprising Zn, Cd, Hg, Cu, Mn, and Ga, subject to the proviso that D is not the same as B′ or B″.

In some embodiments, D comprises at least two dopant ions selected from the group comprising Zn, Cd, Hg, Cu, Mn, and Ga. In some embodiments, A comprises Cs or one of A′ and A″ is Cs. In some embodiments, B comprises Mg or one of B′ and B″ is Mg or Zn. In some embodiments, X comprises at least one of F, Cl, or Br, optionally wherein X comprises CI.

In some embodiments, D comprises Zn, Ga, or Cd. In some embodiments, 0.005≤i≤0.20, optionally 0.05≤i≤0.10. In some embodiments, the composition of Formula (I) is selected from the group comprising Cs₂Mg_{0.95}Zn_{0.05}Cl₄, Cs₂Mg_{0.90}Zn_{0.1}Cl₄, Cs₂Zn_{0.99}Ga_{0.01}Cl₄, Cs₂Zn_{0.985}Ga_{0.015}Cl₄, Cs₂Zn_{0.98}Cd_{0.02}Cl₄, and Cs₂Zn_{0.95}Cd_{0.05}Cl₄.

In some embodiments, the scintillator material comprises a composition of Formula (II): AB₁₋ᵢX₃:Dᵢ (II), wherein: 0.0001≤i≤0.9999; A is one or more monovalent cations selected from the group comprising Tl, In, Li, Na, K, Rb, and Cs; B is one or more divalent cations selected from the group comprising Be, Mg, Ca, Sr, Ba, Zn, Cd and Hg, optionally one or more of Be, Mg, Ca, Sr, and Ba; X is one or more halides selected from the group comprising F, Cl, Br, and I; and D is one or more dopant ions selected from the group comprising Zn, Cd, Hg, Cu, Mn, and Ga, subject to the proviso that D is not the same as B.

In some embodiments, B comprises at least two different divalent cations, optionally wherein the composition of Formula (II) is a composition of Formula (IIa): AB′₁₋ᵢ₋ⱼB″ⱼX₃:Dᵢ (IIa), wherein: 0.0001≤i≤0.9999; 0.0001≤j≤0.9998; A is one or more monovalent cations selected from the group comprising Tl, In, Li, Na, K, Rb, and Cs; B′ and B″ are each a divalent cation selected from the group comprising Be, Mg, Ca, Sr, Ba, Zn, Cd, and Hg, optionally Be, Mg, Ca, Sr, and Ba, subject to the proviso that B′ and B″ are not the same; X is one or more halides selected from the group comprising F, Cl, Br, and I; and D is one or more dopant ions selected from the group comprising Zn, Cd, Hg, Cu, Mn, and Ga, subject to the proviso that D is not the same as B′ or B″.

In some embodiments, A comprises at least two different monovalent cations, optionally wherein the composition of Formula (II) is a composition of Formula (IIb): A′_{1-y}A″_{y}B₁₋ᵢX₃:Dᵢ (IIb), wherein: 0.0001≤i≤0.9999; 0<y<1; A′ and A″ are each a monovalent cation selected from the group comprising Tl, In, Li, Na, K, Rb, and Cs, subject to the proviso that A′ and A″ are not the same; B is one or more divalent cations selected from the group comprising Be, Mg, Ca, Sr, Ba, Zn, Cd, and Hg, optionally Be, Mg, Ca, Sr, and Ba; X is one or more halides selected from the group comprising F, Cl, Br, and I; and D is one or more dopant ions selected from the group comprising Zn, Cd, Hg, Cu, Mn, and Ga, subject to the proviso that D is not the same as B.

In some embodiments, X comprises at least two different halides, optionally wherein the composition of Formula (II) is a composition of Formula (IIc): AB₁₋ᵢX′_{3-w}X″_{w}:Dᵢ (IIc), wherein: 0.0001≤i≤0.9999; 0<w<3; A is one or more monovalent cations selected from the group comprising Tl, In, Li, Na, K, Rb, and Cs; B is one or more divalent cations selected from the group comprising Be, Mg, Ca, Sr, Ba, Zn, Cd, and Hg, optionally Be, Mg, Ca, Sr, and Ba; X′ and X″ are each a halide selected the group comprising F, Cl, Br, and I, subject to the proviso that X′ and X″ are not the same; and D is one or more dopant ions selected from the group comprising Zn, Cd, Hg, Cu, Mn, and Ga, subject to the proviso that D is not the same as B.

In some embodiments, A comprises at least two different monovalent cations, B comprises at least two different divalent cations, and X comprises at least two different halides, optionally wherein the composition of Formula (II) is a composition of Formula (IId): A′_{1-y}A″_{y}B′₁₋ᵢ₋ⱼB″ⱼX′_{3-w}X″_{w}:Dᵢ (IId), wherein: 0.0001≤i≤0.9999; 0.0001≤j≤0.9998; 0<y<1; 0<w<3; A′ and A″ are each a monovalent cation selected from the group comprising Tl, In, Li, Na, K, Rb, and Cs, subject to the proviso that A′ and A″ are not the same; B′ and B″ are each a divalent cation selected from the group comprising Be, Mg, Ca, Sr, Ba, Zn, Cd, and Hg, optionally Be, Mg, Ca, Sr, and Ba, subject to the proviso that B′ and B″ are not the same; X′ and X″ are each a halide selected the group comprising F, Cl, Br, and I, subject to the proviso that X′ and X″ are not the same; and D is one or more dopant ion selected from the group comprising Zn, Cd, Hg, Cu, Mn, and Ga, subject to the proviso that D is not the same as B′ or B″.

In some embodiments, D comprises at least two dopant ions selected from the group comprising Zn, Cd, Hg, and Ga. In some embodiments, A comprises Cs or wherein one of A′ and A″ is Cs. In some embodiments, B comprises Mg or wherein one of B′ and B″ is Mg. In some embodiments, X comprises at least one of F, Cl, or Br, optionally wherein X comprises Cl.

In some embodiments, D comprises Zn. In some embodiments, 0.005≤i≤0.20, optionally 0.05≤i≤0.10. In some embodiments, the composition of Formula (II) is CsMg_{0.95}Zn_{0.05}Cl₃.

In some embodiments, the scintillator material comprises a composition of Formula (III): A₁₋ᵢX:Dᵢ (III), wherein: 0.0001≤i≤0.9999; A is one or more monovalent cations selected from the group comprising Tl, In, Li, Na, K, Rb, and Cs; X is one or more halides selected from the group comprising F, Cl, Br, and I, subject to the proviso that X comprises at least one of the group comprising F, Cl, and Br; and D is one or more dopant ions selected from the group comprising Zn, Cd, Hg, Cu, Mn, and Ga.

In some embodiments, A comprises at least two different monovalent cations, optionally wherein the composition of Formula (III) is a composition of Formula (IIIa): A′_{1-i-y}A″_{y}X:Dᵢ (IIIa), wherein: 0.0001≤i≤0.9999; 0.0001≤y≤0.9998; A′ and A″ are each a monovalent cation selected from the group comprising Tl, In, Li, Na, K, Rb, and Cs, subject to the proviso that A′ and A″ are not the same; X is one or more halides selected from the group comprising F, Cl, Br, and I, subject to the proviso that X comprises at least one of the group comprising F, Cl, and Br; and D is one or more dopant ions selected from the group comprising Zn, Cd, Hg, Cu, Mn, and Ga.

In some embodiments, X comprises at least two different halides, optionally wherein the composition of Formula (III) is a composition of Formula (IIIb): A₁₋ᵢX′_{1-w}X″_{w}:Dᵢ(IIIb), wherein: 0.0001≤i≤0.9999; 0<w<1; A is one or more monovalent cations selected from the group comprising Tl, In, Li, Na, K, Rb, and Cs; X′ and X″ are each a halide selected the group comprising F, Cl, Br, and I, subject to the proviso that X′ and X″ are not the same; and D is one or more dopant ion selected from the group comprising Zn, Cd, Hg, Cu, Mn, and Ga.

In some embodiments, A comprises at least two different monovalent cations and X comprises at least two different halides, optionally wherein the composition of Formula (III) is a composition of Formula (IIIc): A′_{1-i-y}A″_{y}X′_{1-w}X″_{w}:Dᵢ (IIIc), wherein: 0.0001≤i≤0.9999; 0.0001≤y≤0.9998; 0<w<1; A′ and A″ are each a monovalent cation selected from the group comprising Tl, In, Li, Na, K, Rb, and Cs, subject to the proviso that A′ and A″ are not the same; X′ and X″ are each a halide selected the group comprising F, Cl, Br, and I, subject to the proviso that X′ and X″ are not the same; and D is one or more dopant ions selected from the group comprising Zn, Cd, Hg, Cu, Mn, and Ga.

In some embodiments, the scintillator material comprises more than 5 weight % Zn or less than 0.5 wt % Zn. In some embodiments, the scintillator material is selected from the group comprising Cs_{0.997}Zn_{0.003}Cl, Cs_{0.992}Zn_{0.008}Cl, Cs_{0.997}Hg_{0.003}Cl, Cs_{0.997}Ga_{0.003}Cl, and Cs_{0.992}Cd_{0.008}Cl.

In some embodiments, the scintillator material comprises a composition of Formula (IV): A₃B₁₋ᵢX₅:Dᵢ, (IV); wherein: 0.0001≤i≤0.9999; A is one or more monovalent cations selected from the group comprising Tl, In, Li, Na, K, Rb, and Cs; B is one or more divalent cations selected from the group comprising Be, Mg, Ca, Sr, Ba, Zn, Cd and Hg, optionally one or more of Be, Mg, Ca, Sr, and Ba; X is one or more halides selected from the group comprising F, Cl, Br, and I; and D is one or more dopant ions selected from the group comprising Zn, Cd, Hg, Cu, Mn, and Ga, subject to the proviso that D is not the same as B.

In some embodiments, B comprises at least two different divalent cations, optionally wherein the composition of Formula (IV) is a composition of Formula (IVa): A₃B′₁₋ᵢ₋ⱼB″ⱼX₅:Dᵢ (IVa), wherein: 0.0001≤i≤0.9999; 0.0001≤j≤0.9998; A is one or more monovalent cations selected from the group comprising Tl, In, Li, Na, K, Rb, and Cs; B′ and B″ are each a divalent cation selected from the group comprising Be, Mg, Ca, Sr, Ba, Zn, Cd, and Hg, optionally Be, Mg, Ca, Sr, and Ba, subject to the proviso that B′ and B″ are not the same; X is one or more halides selected from the group comprising F, Cl, Br, and I; and D is one or more dopant ions selected from the group comprising Zn, Cd, Hg, Cu, Mn, and Ga, subject to the proviso that D is not the same as B′ or B″.

In some embodiments, A comprises at least two different monovalent cations, optionally wherein the composition of Formula (IV) is a composition of Formula (IVb): A′_{3-y}A″_{y}B₁₋ᵢX₅:Dᵢ (IVb), wherein: 0.0001≤i≤0.9999; 0<y<3; A′ and A″ are each a monovalent cation selected from the group comprising Tl, In, Li, Na, K, Rb, and Cs, subject to the proviso that A′ and A″ are not the same; B is one or more divalent cations selected from the group comprising Be, Mg, Ca, Sr, Ba, Zn, Cd, and Hg, optionally Be, Mg, Ca, Sr, and Ba; X is one or more halides selected from the group comprising F, Cl, Br, and I; and D is one or more dopant ions selected from the group comprising Zn, Cd, Hg, Cu, Mn, and Ga, subject to the proviso that D is not the same as B.

In some embodiments, X comprises at least two different halides, optionally wherein the composition of Formula (IV) is a composition of Formula (IVc): A₃B₁₋ᵢX′_{5-w}X″_{w}:Dᵢ (IVc), wherein: 0.0001≤i≤0.9999; 0<w<5; A is one or more monovalent cations selected from the group comprising Tl, In, Li, Na, K, Rb, and Cs; B is one or more divalent cations selected from the group comprising Be, Mg, Ca, Sr, Ba, Zn, Cd, and Hg, optionally Be, Mg, Ca, Sr, and Ba; X′ and X″ are each a halide selected the group comprising F, Cl, Br, and I, subject to the proviso that X′ and X″ are not the same; and D is one or more dopant ions selected from the group comprising Zn, Cd, Hg, Cu, Mn, and Ga, subject to the proviso that D is not the same as B.

In some embodiments, A comprises at least two different monovalent cations, B comprises at least two different divalent cations, and X comprises at least two different halides, optionally wherein the composition of Formula (IV) is a composition of Formula (lVd): A′_{3-y}A″_{y}B′₁₋ᵢ₋ⱼB″ⱼX'_{5-w}X″_{w}:Dᵢ (IVd), wherein: 0.0001≤i≤0.9999; 0.0001≤j≤0.9998; 0<y<3; 0<w<5; A′ and A″ are each a monovalent cation selected from the group comprising Tl, In, Li, Na, K, Rb, and Cs, subject to the proviso that A′ and A″ are not the same; B′ and B″ are each a divalent cation selected from the group comprising Be, Mg, Ca, Sr, Ba, Zn, Cd, and Hg, optionally Be, Mg, Ca, Sr, and Ba, subject to the proviso that B′ and B″ are not the same; X′ and X″ are each a halide selected the group comprising F, Cl, Br, and I, subject to the proviso that X′ and X″ are not the same; and D is one or more dopant ion selected from the group comprising Zn, Cd, Hg, Cu, Mn, and Ga, subject to the proviso that D is not the same as B′ or B″.

In some embodiments, D comprises at least two dopant ions selected from the group comprising Zn, Cd, Hg, Cu, Mn, and Ga. In some embodiments, A comprises Cs or wherein one of A′ and A″ is Cs. In some embodiments, B comprises Mg or Zn or wherein one of B′ and B″ is Mg or Zn. In some embodiments, X comprises at least one of F, Cl, or Br, optionally wherein X comprises Cl.

In some embodiments, D comprises Zn, Ga, or Cd. In some embodiments, 0.01≤i≤0.25. In some embodiments, the composition of Formula (IV) is selected from the group comprising Cs₃Mg_{0.95}Zn_{0.05}Cl₅, Cs₃Mg_{0.90}Zn_{0.1}Cl₅, Cs₃Mg_{0.75}Zn_{0.25}Cl₅, Cs₃Mg_{0.50}Zn_{0.5}Cl₅, Cs₃Zn_{0.95}Cd_{0.05}Cl₅, Cs₃Zn_{0.98}Cd_{0.02}Cl₅, Cs₃Zn_{0.985}Ga_{0.015}Cl₅, and Cs₃Zn_{0.99}Ga_{0.01}Cl₅.

In some embodiments, the scintillator material has increased light yield, shorter decay time, and/or improved timing resolution compared to a corresponding scintillator material where D is absent.

In some embodiments, the presently disclosed subject matter provides a scintillator material comprising a composition of Formula (V): A₃BX₅ (V), wherein: A is one or more monovalent cations selected from the group comprising Tl, In, Li, Na, K, Rb, and Cs; B is one or more divalent cations selected from the group comprising Be, Mg, Ca, Sr, Ba, Zn, Cd and Hg; and X is one or more halides selected from the group comprising F, Cl, Br, and I.

In some embodiments, A is Cs. In some embodiments, B is Mg or Zn. In some embodiments, X is Cl. In some embodiments, the composition of Formula (V) is Cs₃MgCl₅.

In some embodiments, the presently disclosed subject matter provides a radiation detector comprising a scintillator material comprising a composition of one of Formula (I), Formula (II), Formula (III), or Formula (IV) and a photon detector. In some embodiments, the presently disclosed subject matter provides a radiation detector comprising a scintillator material comprising a composition of Formula (V) and a photon detector. In some embodiments, the presently disclosed subject matter provides a method of detecting gamma rays, X-rays, cosmic rays, and/or particles having an energy of 1 keV or greater, the method comprising using the radiation detector comprising a scintillator material comprising a composition of one of Formula (I), Formula (II), Formula (III), or Formula (IV). In some embodiments, the presently disclosed subject matter provides a method of detecting gamma rays, X-rays, cosmic rays, and/or particles having an energy of 1 keV or greater, the method comprising using the radiation detector comprising a scintillator material comprising a composition of Formula (V).

In some embodiments, the presently disclosed subject matter provides a method of preparing a scintillator material comprising a composition of one of Formula (I), Formula (II), Formula (III), or Formula (IV), wherein the method comprises preparing the composition via the vertical Bridgman technique. In some embodiments, the presently disclosed subject matter provides a method of preparing a scintillator material comprising a composition of Formula (V), wherein the method comprises preparing the composition via the vertical Bridgman technique.

Accordingly, it is an object of the presently disclosed subject matter to provide a scintillator material comprising a composition of one of Formulas (I)-(V); radiation detectors comprising the scintillator materials; methods of detecting gamma rays, X-rays, cosmic rays and/or particles having an energy of 1 keV or greater with the radiation detectors; and methods of preparing the scintillator materials.

An object of the presently disclosed subject matter having been stated hereinabove, and which is achieved in whole or in part by the presently disclosed subject matter, other objects will become evident as the description proceeds hereinbelow.

### BRIEF DESCRIPTION OF THE DRAWINGS

FIGS. 1A-1F are a series of photographic images including (FIGS. 1A-1D) images of as-grown 7 millimeter (mm) diameter crystals of (FIG. 1A) undoped dicesium magnesium tetrachloride (Cs₂MgCl₄), (FIG. 1B) dicesium magnesium tetrachloride where 5% of the magnesium is replaced by zinc (Cs₂Mg_{0.95}Zn_{0.05}Cl₄), i.e., Cs₂MgCl₄ doped with 5 mole (mol) % Zn, (FIG. 1C) undoped cesium magnesium trichloride (CsMgCl₃), and (FIG. 1D) cesium magnesium trichloride where 5% of the magnesium is replaced by zinc (CsMg_{0.95}Zn_{0.05}Cl₃), i.e., CsMgCl₃ doped with 5 mol % Zn. FIGS. 1E and 1F are photographic images of backlit ampoules containing (FIG. 1E) CsMgCl₃ and (FIG. 1F) CsMg_{0.95}Zn_{0.05}Cl₃.

FIGS. 2A and 2B are a pair of graphs showing (FIG. 2A) the measured room temperature X-ray diffraction pattern for dicesium magnesium tetrachloride (Cs₂MgCl₄) compared with the simulated reference pattern (ICDD 04-013-9449) and (FIG. 2B) the measured room temperature X-ray diffraction pattern for cesium magnesium trichloride (CsMgCl₃) compared with the simulated reference pattern (ICDD 04-014-4918).

FIGS. 3A-3D are a photographic image showing cleaved pieces of (FIG. 3A) undoped dicesium magnesium tetrachloride (Cs₂MgCl₄), (FIG. 3B) dicesium magnesium tetrachloride where 5% of the magnesium is replaced by zinc (Cs₂Mg_{0.95}Zn_{0.05}Cl₄, i.e., Cs₂MgCl₄ doped with 5 mole (mol) % zinc), (FIG. 3C) undoped cesium magnesium trichloride (CsMgCl₃), and (FIG. 3D) cesium magnesium trichloride wherein 5% of the magnesium is replaced with zinc (CsMg_{0.95}Zn_{0.05}Cl₃, i.e., CsMgCl₃ doped with 5 mol % Zn). The cleaved pieces were polished and used for characterization of scintillation properties.

FIGS. 4A and 4B are a pair of graphs showing (FIG. 4A) the radioluminescence emission spectra (normalized intensity measured in arbitrary units (a.u.) versus wavelength measured in nanometers (nm)) and (FIG. 4B) the scintillation decay time profiles (normalized counts versus time measured in nanoseconds (ns)) of undoped cesium magnesium trichloride (CsMgCl₃) and cesium magnesium trichloride wherein 5% of the magnesium is replaced by zinc (CsMg_{0.95}Zn_{0.05}Cl₃, i.e., cesium magnesium trichloride doped with 5 mole (mol) % zinc (CsMgCl₃:Zn 5%)). Decay time was fitted with a double exponential function (shown as solid lines) for each composition.

FIG. 5 is a graph of the pulse height spectra (counts versus channel number) of undoped cesium magnesium trichloride (CsMgCl₃) and cesium magnesium trichloride where 5% of the magnesium is replaced by zinc (CsMg_{0.95}Zn_{0.05}Cl₃, i.e., cesium magnesium trichloride doped with 5 mole (mol) % zinc (CsMgCl₃:Zn 5%)) measured under excitation by a 662 kiloelectron volt (keV) cesium-137 (¹³⁷Cs) source. Light yield values (LY) are indicated: 1700 photons per megaelectron volt (ph/MeV) for the undoped material and 32500 ph/MeV for the zinc doped material. The photomultiplier tube (PMT) quantum efficiency (Q.E.) values for the emission spectrum of each composition are also displayed: 21.2% for the undoped material and 22.8% for the doped material.

FIGS. 6A and 6B are graphs showing (FIG. 6A) radioluminescence emission spectra (normalized intensity measured in arbitrary units (a.u.) versus wavelength measured in nanometers (nm)) and (FIG. 6B) scintillation decay time profiles (normalized counts versus time measured in nanoseconds (ns)) of undoped dicesium magnesium tetrachloride (Cs₂MgCl₄) and dicesium magnesium tetrachloride where 5% of the magnesium is replaced by zinc (Cs₂Mg_{0.95}Zn_{0.05}Cl₄, i.e., dicesium magnesium tetrachloride doped with 5 mole (mol) % zinc (Cs₂MgCl₄:Zn 5%)). Decay time was fitted with a single exponential function (shown as solid lines) for each material.

FIG. 7 is a graph of the pulse height spectra (counts versus channel number) of undoped dicesium magnesium tetrachloride (Cs₂MgCl₄) and dicesium magnesium tetrachloride wherein 5% of the magnesium is replaced by zinc (Cs₂Mg_{0.95}Zn_{0.05}Cl₄, i.e., dicesium magnesium tetrachloride doped with 5 mole (mol) % zinc (Cs₂MgCl₄:Zn 5%)) measured under excitation by a 662 kiloelectron volt (keV) cesium-137 (¹³⁷Cs) source. The light yield and photomultiplier tube (PMT) quantum efficiency (Q.E.) values for the emission spectrum of each composition are also displayed: 2200 photons per megaelectron volt (ph/MeV) and 24.5% for the undoped material and 2440 ph/MeV and 24.5% for the zinc doped material.

FIG. 8 is a graph showing the light yield (in photons per megaelectron volt (ph/MeV)) at 662 kiloelectron volt (keV) as function of zinc (Zn) concentration (mole (mol) percent (%)) for zinc-doped dicesium magnesium tetrachloride (Cs₂Mg₁₋ₓZnₓCl₄) crystals, for zinc concentrations from 0 mol % to 100 mol %.

FIGS. 9A-9D are a series of photographic images, including images of as-grown 7 mm diameter crystals of (FIG. 9A) undoped tricesium magnesium pentachloride (Cs₃MgCl₅) and (FIG. 9B) tricesium magnesium pentachloride where 5% of the magnesium is replaced by zinc (Cs₃Mg_{0.95}Zn_{0.05}Cl₅, i.e., tricesium magnesium pentachloride doped with 5 mole (mol) % zinc (Cs₃MgCl₅:Zn 5%)) as well as cleaved pieces of (FIG. 9C) undoped Cs₃MgCl₅ and (FIG. 9D) Cs₃Mg_{0.95}Zn_{0.05}Cl₅ that were polished and used for characterization of scintillation properties.

FIG. 10 is a graph showing (top) the measured room temperature X-ray diffraction pattern for tricesium magnesium pentachloride (Cs₃MgCl₅) compared with (bottom) a simulated reference pattern.

FIGS. 11A and 11B are a pair of graphs showing (FIG. 11A) the radioluminescence emission spectra (normalized intensity measured in arbitrary units (a.u.) versus wavelength measured in nanometers (nm)) and (FIG. 11B) scintillation decay time (normalized counts versus time measured in nanoseconds (ns)) of undoped tricesium magnesium pentachloride (Cs₃MgCl₅; dotted line (FIG. 11A) or circles (FIG. 11B)) and tricesium magnesium pentachloride where 5% of the magnesium is replaced with zinc (Cs₃Mg_{0.95}Zn_{0.05}Cl, i.e., Cs₃MgCl₅ doped with 5 mole (mol) % zinc; solid line (FIG. 11A) or squares (FIG. 11B). Decay time was fitted with a single exponential function (shown as solid lines in FIG. 11B) for each.

FIG. 12 is a graph showing the pulse height spectra of undoped tricesium magnesium pentachloride (Cs₃MgCl₅) and tricesium magnesium pentachloride where 5% of the magnesium is replaced with zinc (Cs₃Mg_{0.95}Zn_{0.05}Cl₅, i.e., Cs₃MgCl₅ doped with 5 mole (mol) % zinc (C₃MgCl₅:Zn 5%) measured under excitation by a 662 keV ¹³⁷Cs source. The light yield and photomultiplier tube (PMT) quantum efficiency (Q.E.) values for the emission spectrum of each composition are also displayed: 1340 photons per megaelectron volt (ph/MeV) and 23.5% for the undoped material and 2100 ph/MeV and 23.5% for the zinc doped material.

FIG. 13 is a graph showing the effect of zinc (Zn)-doping on light yield (measured in photons per Megaelectron volt (ph/MeV)) for three scintillator compounds in the cesium chloride (CsCl)-magnesium dichloride (MgCl₂) system.

FIG. 14 is a graph showing the radioluminescence emission spectra (normalized intensity measured in arbitrary units (a.u.) versus time measured in nanoseconds (ns)) of dicesium zinc tetrachloride (Cs₂ZnCl₄), Cs₂ZnCl₄ doped with 1.5 mole (mol) % gallium (Ga) (i.e., Cs₂ZnCl₄:Ga 1.5%), Cs₂ZnCl₄ doped with 1 mol % Ga (i.e., Cs₂ZnCl₄:Ga 1%), Cs₂ZnCl₄ doped with 2 mol % cadmium (Cd) (i.e., Cs₂ZnCl₄:Cd 2%), and Cs₂ZnCl₄ doped with 5 mol % Cd (i.e., Cs₂ZnCl₄:Cd 5%).

FIG. 15 is a graph showing the radioluminescence emission spectra (normalized intensity measured in arbitrary units (a.u.) versus time measured in nanoseconds (ns)) of cesium chloride (CsCl), CsCl doped with 0.8 mole (mol) % cadmium (Cd) (i.e., CsCl:Cd 0.8%), CsCl doped with 0.3 mol % mercury (Hg) (i.e., CsCl:Hg 0.3%), CsCl doped with 0.3 mol % zinc (Zn) (i.e., CsCl:Zn 0.3%), CsCl doped with 0.8 mol % Zn (i.e., CsCl:Zn 0.8%), and CsCl doped with 0.3 mol % gallium (i.e., CsCl:Ga 0.3%).

FIG. 16 is a graph showing the radioluminescence emission spectra (normalized intensity measured in arbitrary units (a.u.) versus time measured in nanoseconds (ns)) of tricesium zinc pentachloride (Cs₃ZnCl₅), Cs₃ZnCl₅ doped with 1 mole (mol) % gallium (Ga) (i.e., Cs₃ZnCl₅:Ga 1%), Cs₃ZnCl₅ doped with 2 mol % cadmium (Cd) (i.e., Cs₃ZnCl₅:Cd 2%), and Cs₃ZnCl₅ doped with 5 mol % Cd (i.e., Cs₃ZnCl₅:Cd 5%).

FIG. 17 is a graph showing the pulse height spectra (counts versus channel number) of zinc (Zn)-doped tricesium magnesium pentachloride (Cs₃Mg₁₋ₓZnₓCl₅) crystals (measured with a cesium-137 (¹³⁷Cs) source) with varying concentrations of Zn showing improved light yield upon doping/mixing. Materials included undoped tricesium magnesium pentachloride (Cs₃MgCl₅), Cs₃MgCl₅ doped with 5 mole (mol) % zinc (Zn) (i.e., Cs₃MgCl₅:Zn 5%), Cs₃MgCl₅ doped with 10 mol % Zn (i.e., Cs₃MgCl₅:Zn 10%), Cs₃MgCl₅ doped with 25 mol % Zn (i.e., Cs₃MgCl₅:Zn 25%), Cs₃MgCl₅ doped with 50 mol % Zn (i.e., Cs₃MgCl₅:Zn 50%), and tricesium zinc pentachloride (Cs₃ZnCl₅).

FIG. 18 is a schematic drawing of an apparatus for detecting radiation according to an aspect of the presently disclosed subject matter. Apparatus 10 includes photon detector 12 optically coupled to scintillator material 14. Apparatus 10 can optionally include electronics 16 for recording and/or displaying electronic signal from photon detector 12. Thus, optional electronics 16 can be in electronic communication with photon detector 12.

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “one or more” when used in this application in reference to a list or group of one or more items (e.g., one or more chemical elements or ions), can refer to any one of said items, a combination or mixture of any two of said items, a combination or mixture of any three of said items, a combination or mixture of any four of said items etc., including a combination or mixture of all listed items. The combinations of chemical components (e.g., ions) can include any ratio of the components, unless specified otherwise.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise indicated, all numbers expressing quantities of time, temperature, light output, atomic (at) or mole (mol) percentage (%), and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

The term “scintillator” refers to a material that emits light (e.g., visible light) in response to stimulation by high energy radiation (e.g., X, α, β, or γ radiation).

The term “phosphor” as used herein refers to a material that emits light (e.g., visible light) in response to irradiation with electromagnetic or particle radiation.

In some embodiments, the compositional formula expression of an optical material (e.g., a scintillation material or a phosphor) can contain a colon “:” or comma, wherein the composition of the main or base matrix material (e.g., the main A₂BX₄, ABX₃ or AX matrix) is indicated on the left side of the colon or comma, and an activator (or dopant) ion or an activator ion and a codopant ion are indicated on the right side of the colon or comma. When the activator (or dopant) ion or the activator ion and codopant ion is/are indicated, the amount (e.g., mole % or atomic %) of activator (or dopant) ion) or activator and codopant ions can also be indicated on the right of the colon or comma. In some embodiments, the dopant (or dopant and codopant(s)) can replace all or part of the A and/or B ions. For example, “CsMgCl₃:Zn 5%” represents a CsMgCl₃ composition doped with Zn, where 5 mole % of the Mg content is replaced by Zn. Alternatively, the same composition can be represented as CsMg_{0.95}Zn_{0.05}Cl₃

The term “high energy radiation” can refer to electromagnetic radiation having energy higher than that of ultraviolet radiation, including, but not limited to X radiation (i.e., X-ray radiation), alpha (α) particles, gamma (γ) radiation, and beta (β) radiation. In some embodiments, the high energy radiation refers to gamma rays, cosmic rays, X-rays, and/or particles having an energy of 1 keV or greater. Scintillator materials as described herein can be used as components of radiation detectors in apparatuses such as counters, image intensifiers, and computed tomography (CT) scanners.

“Optical coupling” as used herein refers to a physical coupling between a scintillator and a photosensor, e.g., via the presence of optical grease or another optical coupling compound (or index matching compound) that bridges the gap between the scintillator and the photosensor. In addition to optical grease, optical coupling compounds can include, for example, liquids, oils and gels.

“Light output” can refer to the number of light photons produced per unit energy deposited, e.g., by a gamma ray being absorbed, typically the number of light photons/MeV.

As used herein, chemical ions can be represented simply by their chemical element symbols alone (e.g., Cu for copper ion(s) (e.g., Cu²⁺) or Cs for cesium ion(s) (e.g., Cs⁺)).

In some embodiments, the term “transition metal element” as used herein refers to one or more elements selected from titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (db), seborgium (Sg), bohrium (Bh), hassium (Hs), meitnerium (Mt), darmstadtium (Ds), roentgenium (Rg), and copernicium (Cn).

In some embodiments, the term “post-transition metal” refers to one or more of gallium (Ga), indium (In), thallium (TI), tin (Sn), lead (Pb), bismuth (Bi), polonium (Po), and aluminum (AI). In some embodiments, post-transition metal” refers to one or more of Ga, In, Tl, Sn, Pb, and Bi.

### II. Halide Scintillator Compositions

The presently disclosed subject matter provides, in one aspect, inorganic halide scintillators for use in optical and/or radiation detection applications. For example, in some embodiments, improved scintillation properties can be achieved with inorganic halide scintillators, such as A₃BX₅, A₂BX₄, ABX₃, and AX-type compounds based on CsCl-containing binary and ternary CVL scintillators, when doped with metal ions, e.g., transition metal or post-transition metal ions, such as, but not limited to, Zn, Cd, Hg, Cu, Mn, and/or Ga (i.e., Zn, Cd, Hg, Cu, Mn, Ga, or any combination thereof). In some embodiments, A is one or more monovalent cations such as Tl, In, Li, Na, K, Rb, and/or Cs (i.e., Tl, In, Li, Na, K, Rb, Cs or any combination thereof). In some embodiments, B is one or more divalent cations such as Be, Mg, Ca, Sr, Ba, Zn, Cd, and/or Hg (i.e., Be, Mg, Ca, Sr, Ba, Zn, Cd, Hg or any combination thereof). In some embodiments, X is one or more halogen ions such as F, Cl, Br, and/or I (i.e., F, Cl, Br, I or any combination thereof). In some embodiments, X comprises at least one of F, Cl, or Br. In some embodiments, dopant, D, is one or more dopant ions (e.g., one or more dopant cations), such as one or more ions of Zn, Cd, Hg, Cu, Mn, and/or Ga. In some embodiments, D comprises a mixture of ions comprising at least two of Zn, Cd, Hg, Cu, Mn, and Ga. In some embodiments, B and D are not the same (i.e., are not the same ion or the same mixture of ions). The presently disclosed subject matter further provides undoped inorganic halide scintillators of the type A₃BX₅.

In some embodiments, the presently disclosed subject matter provides a scintillator material comprising a composition of one of Formulas (I), (II), (III) or (IV):

A₂B₁₋ᵢX₄:Dᵢ (I),

AB₁₋ᵢX₃:Dᵢ (II),

A₁₋ᵢX:Dᵢ (III); or

A₃B₁₋ᵢX₅:D (IV);

wherein: 0.0001≤i≤0.9999; A is one or more monovalent cations (e.g., selected from the group comprising Tl, In, Li, Na, K, Rb, and Cs); B is one or more divalent cations (e.g., selected from the group comprising Be, Mg, Ca, Sr, Ba, Zn, Cd and Hg); X is one or more halide ion selected from the group comprising F, Cl, Br, and I; and D is one or more transition metal or post-transition metal dopant ions (e.g., selected from the group comprising Zn, Cd, Hg, Cu, Mn, and Ga). In some embodiments, in compositions of Formula (I) (II), or (IV), D is not the same as B.

In some embodiments, e.g., when the scintillator material comprises a composition of Formula (III), X in the composition of Formula (III) comprises at least one of F, Cl, and Br. In some embodiments, A is one or more monovalent cations selected from the group comprising Li, Na, K, Rb, and Cs. In some embodiments, B is one or more divalent cations selected from the group comprising Be, Mg, Ca, Sr, and Ba. In some embodiments. 0.0001≤i≤0.5. In some embodiments 0.0001≤i≤0.25. In some embodiments, 0.001≤i≤0.20. In some embodiments, i is about 0.001, 0.002, 0.003, 0.004, 0.005, 0.006, 0.007, 0.008, 0.009, 0.010, 0.050, 0.10, 0.15, or about 0.20. In some embodiments, 0.01≤i≤0.15. In some embodiments, i is about 0.01, 0.02, 0.03, 0.04, 0.05, 0.06, 0.07, 0.08, 0.09, 0.10, 0.11, 0.12, 0.13, 0.14, or about 0.15. In some embodiments, i is about 0.05. In some embodiments, i is about 0.10.

In some embodiments, the scintillator material comprises a mixture of at least two different compositions of Formulas (I)-(IV). For example, the scintillator material can include a mixture of two different compositions of the Formula (I) or mixture of a composition of Formula (I) and a composition of Formula (II), (III), or (IV).

In some embodiments, the scintillator material comprises a composition of one of Formulas (I), (II) or (III).

In some embodiments, D comprises one or more of Zn, Cd, Hg, and Ga. In some embodiments, D comprises Zn. In some embodiments, A comprises Cs. In some embodiments, B comprises Mg. In some embodiments, B comprises Zn. In some embodiments, X comprises or consists of Cl.

In some embodiments, the scintillator material comprises a composition of Formula (I):

A₂B₁₋ᵢX₄:Dᵢ (I),

wherein: 0.0001≤i≤0.9999; A is one or more monovalent cations selected from the group comprising Tl, In, Li, Na, K, Rb, and Cs (optionally one or more of Li, Na, K, Rb, and Cs); B is one or more divalent cations selected from the group comprising Be, Mg, Ca, Sr, Ba, Zn, Cd and Hg (optionally one or more of Be, Mg, Ca, Sr, and Ba); X is one or more halides selected from the group comprising F, Cl, Br, and I; and D is one or more dopant ions selected from the group comprising Zn, Cd, Hg, Cu, Mn, and Ga. In some embodiments, D is not the same as B.

In some embodiments, B comprises at least two different divalent cations. In some embodiments, B is a mixture of two different divalent cations selected from the group comprising Be, Mg, Ca, Sr, Ba, Zn, Cd, and Hg. In some embodiments, the composition of Formula (I) is a composition of Formula (Ia):

A₂B′₁₋ᵢ₋ⱼB″ⱼX₄:Dᵢ (Ia),

wherein: 0.0001≤i≤0.9999; 0.0001≤j≤0.9998; A is one or more monovalent cations selected from the group comprising Tl, In, Li, Na, K, Rb, and Cs (optionally one or more of Li, Na, K, Rb, or Cs); B′ and B″ are each a divalent cation selected from the group comprising Be, Mg, Ca, Sr, Ba, Zn, Cd, and Hg (optionally one or more of Be, Mg, Ca, Sr, and Ba), and subject to the proviso that B′ and B″ are not the same; X is one or more halides selected from the group comprising F, Cl, Br, and I; and D is one or more dopant ions selected from the group comprising Zn, Cd, Hg, Cu, Mn, and Ga, subject to the proviso that D is not the same as B′ or B″.

In some embodiments, A comprises at least two different monovalent cations. In some embodiments, A is a mixture of two different monovalent cations selected from Tl, In, Li, Na, K, Rb, and Cs. In some embodiments, the composition of Formula (I) is a composition of Formula (Ib):

A′_{2-y}A″_{y}B₁₋ᵢX₄:Dᵢ (Ib),

wherein: 0.0001≤i≤0.9999; 0<y<2; A′ and A″ are each a monovalent cation selected from the group comprising Tl, In, Li, Na, K, Rb, and Cs (optionally wherein at least one of A′ and A″ is Li, Na, K, Rb, or Cs), and subject to the proviso that A′ and A″ are not the same; B is one or more divalent cations selected from the group comprising Be, Mg, Ca, Sr, Ba, Zn, Cd, and Hg (optionally selected from the group comprising Be, Mg, Ca, Sr, and Ba); X is one or more halides selected from the group comprising F, Cl, Br, and I; and D is one or more dopant ions selected from the group comprising Zn, Cd, Hg, Cu, Mn, and Ga, subject to the proviso that D is not the same as B.

In some embodiments, the scintillator material comprises at least two different halides. In some embodiments, X is a mixture of two different halides, X′ and X″. In some embodiments, the composition of Formula (I) is a composition of Formula (Ic):

A₂B₁₋ᵢX′_{4-w}X″_{w}:Dᵢ (Ic),

wherein: 0.0001≤i≤0.9999; 0<w<4; A is one or more monovalent cations selected from the group comprising Tl, In, Li, Na, K, Rb, and Cs (optionally selected from the group comprising Li, Na, K, Rb, and Cs); B is one or more divalent cations selected from the group comprising Be, Mg, Ca, Sr, Ba, Zn, Cd, and Hg (optionally selected from the group comprising Be, Mg, Ca, Sr, and Ba); X′ and X″ are each a halide selected the group comprising F, Cl, Br, and I, subject to the proviso that X′ and X″ are not the same; and D is one or more dopant ions selected from the group comprising Zn, Cd, Hg, Cu, Mn, and Ga, subject to the proviso that D is not the same as B.

In some embodiments, A comprises at least two different monovalent cations, B comprises at least two different divalent cations, and X comprises at least two different halides. In some embodiments, A is a mixture of two different monovalent cations (A′ and A″), B is a mixture of two different divalent cations (B′ and B″), and X is a mixture of two different halides (X′ and X″). In some embodiments, the composition of Formula (I) is a composition of Formula (Id):

A′_{2-y}A″_{y}B′₁₋ᵢ₋ⱼ B″ⱼX′_{4-w}X″_{w}:Dᵢ (Id),

wherein: 0.0001≤i≤0.9999; 0.0001≤j≤0.9998; 0<y<2; 0<w<4; A′ and A″ are each a monovalent cation selected from the group comprising Tl, In, Li, Na, K, Rb, and Cs (optionally selected from the group comprising Li, Na, K, Rb, and Cs), and subject to the proviso that A′ and A″ are not the same; B′ and B″ are each a divalent cation selected from the group comprising Be, Mg, Ca, Sr, Ba, Zn, Cd, and Hg (optionally selected from the group comprising Be, Mg, Ca, Sr, and Ba), and subject to the proviso that B′ and B″ are not the same; X′ and X″ are each a halide selected the group comprising F, Cl, Br, and I, subject to the proviso that X′ and X″ are not the same; and D is one or more dopant ions selected from the group comprising Zn, Cd, Hg, Cu, Mn, and Ga, subject to the proviso that D is not the same as B′ or B″.

In some embodiments, in any of Formulae (I), (Ia), (Ib), (Ic) and (Id), D is a mixture of ions of at least two of Zn, Cd, Hg, Cu, Mn, and Ga.

In some embodiments, A comprises Cs (e.g., one of A′ and A″ is Cs). In some embodiments, B comprises Mg or Zn. (e.g., one of B′ and B″ is Mg or Zn). In some embodiments, X comprises at least one of F, Cl, and Br (e.g., one of X′ and X″ is F, Cl, or Br). In some embodiments X comprises Cl (e.g., one of X′ and X″ is Cl). In some embodiments, D comprises Zn, Ga, or Cd. In some embodiments, D comprises Zn.

In some embodiments, 0.005≤i≤0.20. In some embodiments, 0.05≤i≤0.10. In some embodiments, i=0.05. In some embodiments, i=0.10.

In some embodiments, the composition of Formula (I) is selected from the group comprising: Cs₂Mg_{0.95}Zn_{0.05}Cl₄ (i.e., Cs₂MgCl₄:Zn 5%), Cs₂Mg_{0.90}Zn_{0.1}Cl₄ (i.e., Cs₂MgCl₄:Zn 10%), Cs₂Zn_{0.99}Ga_{0.01}Cl₄ (i.e., Cs₂ZnCl₄:Ga 1%), Cs₂Zn_{0.985}Ga_{0.015}Cl₄ (i.e., Cs₂ZnCl₄:Ga 1.5%), Cs₂Zn_{0.98}Cd_{0.02}Cl₄ (i.e., Cs₂ZnCl₄:Cd 2%), and Cs₂Zn_{0.95}Cd_{0.05}Cl₄ (i.e., Cs₂ZnCl₄:Cd 5%).

In some embodiments, the scintillator material comprises a composition of Formula (II):

AB₁₋ᵢX₃:Dᵢ (II),

wherein: 0.0001≤i≤0.9999; A is one or more monovalent cations selected from the group comprising Tl, In, Li, Na, K, Rb, and Cs (optionally selected from the group comprising Li, Na, K, Rb, and Cs); B is one or more divalent cations selected from the group comprising Be, Mg, Ca, Sr, Ba, Zn, Cd, and Hg (optionally selected from the group comprising one or more of Be, Mg, Ca, Sr, and Ba); X is one or more halides selected from the group comprising F, Cl, Br, and I; and D is one or more dopant ions selected from the group comprising Zn, Cd, Hg, Cu, Mn, and Ga. In some embodiments, D is not the same as B.

In some embodiments, B comprises at least two different divalent cations. In some embodiments, B is a mixture of two different divalent cations, B′ and B″. In some embodiments, the composition of Formula (II) is a composition of Formula (IIa):

AB′₁₋ᵢ₋ⱼB″ⱼX₃:Dᵢ (IIa),

wherein: 0.0001≤i≤0.9999; 0.0001≤j≤0.9998; A is one or more monovalent cations selected from the group comprising Tl, In, Li, Na, K, Rb, and Cs (optionally selected from the group comprising Li, Na, K, Rb, and Cs); B′ and B″ are each a divalent cation selected from the group comprising Be, Mg, Ca, Sr, Ba, Zn, Cd, and Hg (optionally selected from the group comprising Be, Mg Ca, Sr, and Ba), and subject to the proviso that B′ and B″ are not the same; X is one or more halides selected from the group comprising F, Cl, Br, and I; and D is one or more dopant ions selected from the group comprising Zn, Cd, Hg, Cu, Mn, and Ga, subject to the proviso that D is not the same as B′ or B″.

In some embodiments, A comprises at least two different monovalent cations. In some embodiments, A is a mixture of two different monovalent cations, A′ and A″. In some embodiments, the composition of Formula (II) is a composition of Formula (IIb):

A′_{1-y}A″_{y}B₁₋ᵢX₃:Dᵢ (IIb),

wherein: 0.0001≤i≤0.9999; 0<y<1; A′ and A″ are each a monovalent cation selected from the group comprising Tl, In, Li, Na, K, Rb, and Cs (optionally selected from the group comprising Li, Na, K, Rb, and Cs), and subject to the proviso that A′ and A″ are not the same; B is one or more divalent cations selected from the group comprising Be, Mg, Ca, Sr, Ba, Zn, Cd, and Hg (optionally selected from the group comprising Be, Mg, Ca, Sr, and Ba); X is one or more halides selected from the group comprising F, Cl, Br, and I; and D is one or more dopant ions selected from the group comprising Zn, Cd, Hg, Cu, Mn, and Ga, subject to the proviso that D is not the same as B.

In some embodiments, X comprises at least two different halides. In some embodiments, X is a mixture of two different halides, X′ and X″. In some embodiments, the composition of Formula (II) is a composition of Formula (IIc):

AB₁₋ᵢX′_{3-w}X″_{w}:Dᵢ (IIC),

wherein: 0.0001≤i≤0.9999; 0<w<3; A is one or more monovalent cations selected from the group comprising Tl, In, Li, Na, K, Rb, and Cs (optionally selected from the group comprising Li, Na, K, Rb, and Cs); B is one or more divalent cations selected from the group comprising Be, Mg, Ca, Sr, Ba, Zn, Cd, and Hg (optionally selected from the group comprising Be, Mg, Ca, Sr, and Ba); X′ and X″ are each a halide selected the group comprising F, Cl, Br, and I, subject to the proviso that X′ and X″ are not the same; and D is one or more dopant ions selected from the group comprising Zn, Cd, Hg, Cu, Mn, and Ga, subject to the proviso that D is not the same as B.

In some embodiments, A comprises at least two different monovalent cations, B comprises at least two different monovalent cations, and X comprises at least two different halides. In some embodiments, A is a mixture of two different monovalent cations, B is a mixture of two different divalent cations, and/or X is a mixture of two different halides. In some embodiments, the composition of Formula (II) is a composition of Formula (IId):

A′_{1-y}A″_{y}B′₁₋ᵢ₋ⱼB″ⱼX′_{3-w}X″_{w}:Dᵢ (IId),

wherein: 0.0001≤i≤0.9999; 0.0001≤j≤0.9998; 0<y<1; 0<w<3; A′ and A″ are each a monovalent cation selected from the group comprising Tl, In, Li, Na, K, Rb, and Cs (optionally selected from the group comprising Li, Na, K, Rb, and Cs), and subject to the proviso that A′ and A″ are not the same; B′ and B″ are each a divalent cation selected from the group comprising Be, Mg, Ca, Sr, Ba, Zn, Cd, and Hg (optionally selected from the group comprising Be, Mg, Ca, Sr, and Ba), and subject to the proviso that B′ and B″ are not the same; X′ and X″ are each a halide selected the group comprising F, Cl, Br, and I, subject to the proviso that X′ and X″ are not the same; and D is one or more dopant ions selected from the group consisting of Zn, Cd, Hg, Cu, Mn, and Ga, subject to the proviso that D is not the same as B′ or B″.

In some embodiments, in any one of Formulae (II), (IIa), (IIb), (IIc), and (IId), D is a mixture of ions of at least two of Zn, Cd, Hg, Cu, Mn, and Ga.

In some embodiments, A comprises Cs (e.g., one of A′ and A″ is Cs).

In some embodiments, B comprises Mg (e.g., one of B′ and B″ is Mg). In some embodiments, X comprises at least one of F, Cl, or Br (e.g., one of X′ and X″ is F, Cl, or Br). In some embodiments, X comprises Cl (e.g., one of X′ and X″ is Cl).

In some embodiments, D comprises or consists of Zn. In some embodiments, 0.005≤i≤0.20. In some embodiments, 0.05≤i≤0.10. In some embodiments, i=0.05. In some embodiments, the composition of Formula (II) is CsMg_{0.95}Zn_{0.05}Cl₃ (i.e., CsMgCl₃:Zn 5%).

In some embodiments, the scintillator material comprises a composition of Formula (III):

A₁₋ᵢX:Dᵢ (III),

wherein: 0.0001≤i≤0.9999; A is one or more monovalent cations selected from the group comprising Tl, In, Li, Na, K, Rb, and Cs (optionally selected from the group comprising Li, Na, K, Rb, and Cs); X is one or more halides selected from the group comprising F, Cl, Br, and I; and D is one or more dopant ions selected from the group comprising Zn, Cd, Hg, Cu, Mn, and Ga. In some embodiments, X comprises at least one of F, Cl, and Br.

In some embodiments, A comprises at least two different monovalent cations. In some embodiments, A is a mixture of two different monovalent cations, A′ and A″. In some embodiments, the composition of Formula (III) is a composition of Formula (IIIa):

A′_{1-i-y}A″_{y}X:Dᵢ (IIIa),

wherein: 0.0001≤i≤0.9999; 0.0001≤y≤0.9998; A′ and A″ are each a monovalent cation selected from the group comprising Tl, In, Li, Na, K, Rb, and Cs (optionally selected from the group comprising Li, Na, K, Rb, and Cs), and subject to the proviso that A′ and A″ are not the same; X is one or more halides selected from the group comprising F, Cl, Br, and I, subject to the proviso that X comprises at least one of F, Cl, and Br; and D is one or more dopant ions selected from the group comprising Zn, Cd, Hg, Cu, Mn, and Ga.

In some embodiments, X comprises at least two different halides. In some embodiments, X is a mixture of two different halides, X′ and X″. In some embodiments, the composition of Formula (III) is a composition of Formula (IIIb):

A₁₋ᵢX′_{1-w}X″_{w}:Dᵢ (IlIb),

wherein: 0.0001≤i≤0.9999; 0<w<1; A is one or more monovalent cations selected from the group consisting of Tl, In, Li, Na, K, Rb, and Cs (optionally selected from the group comprising Li, Na, K, Rb, and Cs); X′ and X″ are each a halide selected the group comprising F, Cl, Br, and I, subject to the proviso that X′ and X″ are not the same; and D is one or more dopant ions selected from the group comprising Zn, Cd, Hg, Cu, Mn, and Ga.

In some embodiments, A comprises at least two different monovalent cations and X comprises at least two different halides. In some embodiments, A is a mixture of two different monovalent cations and X is mixture of two different halides. In some embodiments, the composition of Formula (III) is a composition of Formula (IIIc):

A′_{1-i-y}A″_{y}X′_{1-w}X″_{w}:Dᵢ (IIIc),

wherein: 0.0001≤i≤0.9999; 0.0001≤y≤0.9998; 0<w<1; A′ and A″ are each a monovalent cation selected from the group comprising Tl, In, Li, Na, K, Rb, and Cs (optionally selected from the group comprising Li, Na, K, Rb, and Cs), and subject to the proviso that A′ and A″ are not the same; X′ and X″ are each a halide selected the group comprising F, Cl, Br, and I, subject to the proviso that X′ and X″ are not the same; and D is one or more dopant ions selected from the group comprising Zn, Cd, Hg, Cu, Mn, and Ga.

In some embodiments, in any one of Formulae (III), (IIIa), (IIIb), and (IIIc), D is a mixture of ions of at least two of Zn, Cd, Hg, Cu, Mn, and Ga.

In some embodiments, A comprises Cs (e.g., one of A′ and A″ is Cs). In some embodiments, X comprises at least one of F, Cl, or Br (e.g., one of X′ and X″ is F, Cl, or Br). In some embodiments, X comprises Cl (e.g., one of X′ and X″ is Cl).

In some embodiments, D comprises one or more of Zn, Cd, Hg, and Ga. In some embodiments, 0.001≤i≤0.20. In some embodiments, 0.001≤i≤0.10. In some embodiments, 0.001≤i≤0.05 (e.g., about 0.001, 0.002, 0.003, 0.004, 0.005, 0.006, 0.007, 0.008, 0.009, 0.01, 0.02, 0.03, 0.04, or about 0.05). In some embodiments, 0.001≤i≤0.01. In some embodiments, i=0.003. In some embodiments, i=0.008. In some embodiments, the composition of Formula (III) is selected from the group comprising Cs_{0.997}Zn_{0.003}Cl (i.e., CsCl:Zn 0.3%), Cs_{0.992}Zn_{0.008}Cl (i.e., CsCl:Zn 0.8%), Cs_{0.997}Hg_{0.003}Cl (i.e., CsCl:Hg 0.3%), Cs_{0.997}Ga_{0.003}Cl (i.e., CsClGa 0.3%), and Cs_{0.992}Cd_{0.008}Cl (i.e., CsCl:Cd 0.8%).

In some embodiments, the scintillator material comprises a composition of Formula (IV):

A₃B₁₋ᵢX₅:Dᵢ (IV),

wherein: 0.0001≤i≤0.9999; A is one or more monovalent cations selected from the group consisting of Tl, In, Li, Na, K, Rb, and Cs (optionally one or more of Li, Na, K, Rb, and Cs); B is one or more divalent cations selected from the group consisting of Be, Mg, Ca, Sr, Ba, Zn, Cd and Hg (optionally one or more of Be, Mg, Ca, Sr, and Ba); X is one or more halides selected from the group consisting of F, Cl, Br, and I; and D is one or more dopant ions selected from the group consisting of Zn, Cd, Hg, Cu, Mn, and Ga. In some embodiments, D is not the same as B.

In some embodiments, B comprises at least two different divalent cations. In some embodiments, B is a mixture of two different divalent cations selected from Be, Mg, Ca, Sr, Ba, Zn, Cd, and Hg. In some embodiments, the composition of Formula (IV) is a composition of Formula (IVa):

A₃B′₁₋ᵢ₋ⱼB″ⱼX₅:Dᵢ (IVa),

wherein: 0.0001≤i≤0.9999; 0.0001≤j≤0.9998; A is one or more monovalent cations selected from the group comprising Tl, In, Li, Na, K, Rb, and Cs (optionally one or more of Li, Na, K, Rb, or Cs); B′ and B″ are each a divalent cation selected from the group comprising Be, Mg, Ca, Sr, Ba, Zn, Cd, and Hg (optionally one or more of Be, Mg, Ca, Sr, and Ba), and subject to the proviso that B′ and B″ are not the same; X is one or more halides selected from the group comprising F, Cl, Br, and I; and D is one or more dopant ions selected from the group consisting of Zn, Cd, Hg, Cu, Mn, and Ga, subject to the proviso that D is not the same as B′ or B″.

In some embodiments, A comprises at least two different monovalent cations. In some embodiments, A is a mixture of two different monovalent cations selected from Tl, In, Li, Na, K, Rb, and Cs. In some embodiments, the composition of Formula (IV) is a composition of Formula (IVb):

A′_{3-y}A″_{y}B₁₋ᵢX₅:Dᵢ (IVb),

wherein: 0.0001≤i≤0.9999; 0<y<3; A′ and A″ are each a monovalent cation selected from the group comprising Tl, In, Li, Na, K, Rb, and Cs (optionally wherein at least one of A′ and A″ is Li, Na, K, Rb, or Cs), and subject to the proviso that A′ and A″ are not the same; B is one or more divalent cations selected from the group comprising Be, Mg, Ca, Sr, Ba, Zn, Cd, and Hg (optionally selected from the group comprising Be, Mg, Ca, Sr, and Ba); X is one or more halides selected from the group comprising F, Cl, Br, and I; and D is one or more dopant ions selected from the group comprising Zn, Cd, Hg, Cu, Mn, and Ga, subject to the proviso that D is not the same as B.

In some embodiments, the scintillator material comprises at least two different halides. In some embodiments, X is a mixture of two different halides, X′ and X″. In some embodiments, the composition of Formula (IV) is a composition of Formula (IVc):

A₃B₁₋ᵢX′_{5-w}X″_{w}:Dᵢ (IVc),

wherein: 0.0001≤i≤0.9999; 0<w<5; A is one or more monovalent cations selected from the group comprising Tl, In, Li, Na, K, Rb, and Cs (optionally selected from the group comprising Li, Na, K, Rb, and Cs); B is one or more divalent cations selected from the group comprising Be, Mg, Ca, Sr, Ba, Zn, Cd, and Hg (optionally selected from the group comprising Be, Mg, Ca, Sr, and Ba); X′ and X″ are each a halide selected the group comprising F, Cl, Br, and I, subject to the proviso that X′ and X″ are not the same; and D is one or more dopant ions selected from the group consisting of Zn, Cd, Hg, Cu, Mn, and Ga, subject to the proviso that D is not the same as B.

In some embodiments, A comprises at least two different monovalent cations, B comprises at least two different divalent cations, and X comprises at least two different halides. In some embodiments, A is a mixture of two different monovalent cations (A′ and A″), B is a mixture of two different divalent cations (B′ and B″), and X is a mixture of two different halides (X′ and X″). In some embodiments, the composition of Formula (IV) is a composition of Formula (IVd):

A′_{3-y}A″_{y}B′₁₋ᵢ₋ⱼB″ⱼX′_{5-w}X″_{w}:Dᵢ (IVd),

wherein: 0.0001≤i≤0.9999; 0.0001≤j≤0.9998; 0<y<3; 0<w<5; A′ and A″ are each a monovalent cation selected from the group comprising Tl, In, Li, Na, K, Rb, and Cs (optionally selected from the group comprising Li, Na, K, Rb, and Cs), and subject to the proviso that A′ and A″ are not the same; B′ and B″ are each a divalent cation selected from the group comprising Be, Mg, Ca, Sr, Ba, Zn, Cd, and Hg (optionally selected from the group comprising Be, Mg, Ca, Sr, and Ba), and subject to the proviso that B′ and B″ are not the same; X′ and X″ are each a halide selected the group comprising F, Cl, Br, and I, subject to the proviso that X′ and X″ are not the same; and D is one or more dopant ions selected from the group comprising Zn, Cd, Hg, Cu, Mn, and Ga, subject to the proviso that D is not the same as B′ or B″.

In some embodiments, in any of Formulae (IV), (IVa), (IVb), (IVc) and (IVd), D is a mixture of ions of at least two of Zn, Cd, Hg, Cu, Mn, and Ga.

In some embodiments, A comprises Cs (e.g., one of A′ and A″ is Cs).

In some embodiments, B comprises Mg (e.g., one of B′ and B″ is Mg). In some embodiments, B comprises Zn (e.g., one of B′ and B″ is Zn). In some embodiments, X comprises at least one of F, Cl, and Br (e.g., one of X′ and X″ is F, Cl, or Br). In some embodiments X comprises Cl (e.g., one of X′ and X″ is Cl). In some embodiments, D comprises Zn, Ga, and/or Cd.

In some embodiments. 0.001≤i≤0.5. In some embodiments 0.001≤i≤0.25. In some embodiments, 0.001≤i≤0.25. In some embodiments, i is about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.10, 0.15, 0.20, 0.21, 0.22, 0.23, 0.24, or about 0.25. In some embodiments, 0.01≤i≤0.25. In some embodiments, 0.005≤i≤020. In some embodiments, 0.05≤i≤0.10. In some embodiments, i is selected from 0.01, 0.015, 0.02, 0.05, 0.10, 0.25, and 0.5. In some embodiments, i=0.05. In some embodiments, i=0.10.

In some embodiments, the composition of Formula (IV) is selected from the group comprising: Cs₃Mg_{0.95}Zn_{0.05}Cl₅ (i.e., Cs₃MgCl₅:Zn 5%), Cs₃Mg_{0.90}Zn_{0.1}Cl₅ (i.e., Cs₃MgCl₅:Zn 10%), Cs₃Mg_{0.75}Zn_{0.25}Cl₅ (i.e., Cs₃MgCl₅:Zn 25%), Cs₃Mg_{0.50}Zn_{0.5}Cl₅ (i.e., Cs₃MgCl₅:Zn 50%), Cs₃Zn_{0.95}Cd_{0.05}Cl₅ (i.e., Cs₃ZnCl₅:Cd 5%), Cs₃Zn_{0.95}Cd_{0.02}Cl₅ (i.e., Cs₃ZnCl₅:Cd 2%), Cs₃Zn_{0.985}Ga_{0.015}Cl₅ (i.e., Cs₃ZnCl₅:Ga 1.5%), and Cs₃Zn_{0.99}Ga_{0.01}Cl₅ (i.e., Cs₃ZnCl₅:Ga 1%).

In some embodiments, when the scintillator material comprises a composition of Formula (III), and the composition of Formula (III) comprises Cs and Tl, the composition of Formula (III) comprises at least one halide other than iodide (1). In some embodiments, when the scintillator material is a composition of Formula (III), X in the composition of Formula (III) is one or more or two or more halides selected from F, Cl, and Br. In some embodiments, when the composition of Formula (III) comprises Cs and Tl, the composition is doped with Zn, Hg, Cu, Mn, or Ga (or with Zn, Hg, or Ga). In some embodiments, when the scintillator material comprises a composition of Formula (III) and the composition of Formula (III) is doped with Zn, the Zn is present at more than 5 weight percent or the composition of Formula (III) is also doped with at least one other dopant selected from Cd, Hg, Cu, Mn, and Ga. In some embodiments, when the composition of Formula (III) is doped with Zn, the Zn is present at less than 0.5 weight percent or the composition is also doped with at least one other dopant selected from Cd, Hg, Cu, Mn, and Ga. In some embodiments, when D is Zn, i<0.62 or >6.1.

In some embodiments, the composition of Formula (I), (II), (III) or (IV) has increased light yield, shorter decay time, and/or improved timing resolution compared to a corresponding scintillator material where D is absent.

In some embodiments, the scintillator material comprises or consists of an undoped ternary inorganic halide scintillator material comprising a composition of Formula (V):

A₃BX₅ (V),

wherein: A is one or more monovalent cations selected from the group consisting of Tl, In, Li, Na, K, Rb, and Cs (optionally one or more of Li, Na, K, Rb, and Cs); B is one or more divalent cations selected from the group consisting of Be, Mg, Ca, Sr, Ba, Zn, Cd and Hg (optionally one or more of Be, Mg, Ca, Sr, and Ba); and X is one or more halides selected from the group consisting of F, Cl, Br, and I.

In some embodiments, B comprises at least two different divalent cations. In some embodiments, B is a mixture of two different divalent cations selected from Be, Mg, Ca, Sr, Ba, Zn, Cd, and Hg. In some embodiments, the composition of Formula (V) is a composition of Formula (Va):

A₃B′₁₋ⱼB″ⱼX₅ (Va),

wherein: 0<j<1 (e.g., 0.0001≤j≤0.9999); A is one or more monovalent cations selected from the group comprising Tl, In, Li, Na, K, Rb, and Cs (optionally one or more of Li, Na, K, Rb, or Cs); B′ and B″ are each a divalent cation selected from the group comprising Be, Mg, Ca, Sr, Ba, Zn, Cd, and Hg (optionally one or more of Be, Mg, Ca, Sr, and Ba), and subject to the proviso that B′ and B″ are not the same; and X is one or more halides selected from the group comprising F, Cl, Br, and I.

In some embodiments, A comprises at least two different monovalent cations. In some embodiments, A is a mixture of two different monovalent cations selected from Tl, In, Li, Na, K, Rb, and Cs. In some embodiments, the composition of Formula (V) is a composition of Formula (Vb):

A′_{3-y}A″_{y}BᵢX₅ (Vb),

wherein: 0<y<3; A′ and A″ are each a monovalent cation selected from the group comprising Tl, In, Li, Na, K, Rb, and Cs (optionally wherein at least one of A′ and A″ is Li, Na, K, Rb, or Cs), and subject to the proviso that A′ and A″ are not the same; B is one or more divalent cations selected from the group comprising Be, Mg, Ca, Sr, Ba, Zn, Cd, and Hg (optionally selected from the group comprising Be, Mg, Ca, Sr, and Ba); and X is one or more halides selected from the group comprising F, Cl, Br, and I.

In some embodiments, the scintillator material comprises at least two different halides. In some embodiments, X is a mixture of two different halides, X′ and X″. In some embodiments, the composition of Formula (V) is a composition of Formula (Vc):

A₃BX'_{5-w}X″_{w} (Vc),

wherein: 0<w<5; A is one or more monovalent cations selected from the group comprising Tl, In, Li, Na, K, Rb, and Cs (optionally selected from the group comprising Li, Na, K, Rb, and Cs); B is one or more divalent cations selected from the group comprising Be, Mg, Ca, Sr, Ba, Zn, Cd, and Hg (optionally selected from the group comprising Be, Mg, Ca, Sr, and Ba); and X′ and X″ are each a halide selected the group comprising F, Cl, Br, and I, subject to the proviso that X′ and X″ are not the same.

In some embodiments, A comprises at least two different monovalent cations, B comprises at least two different divalent cations, and X comprises at least two different halides. In some embodiments, A is a mixture of two different monovalent cations (A′ and A″), B is a mixture of two different divalent cations (B′ and B″), and X is a mixture of two different halides (X′ and X″). In some embodiments, the composition of Formula (V) is a composition of Formula (Vd):

A′_{3-y}A″_{y}B′₁₋ⱼB″ⱼX′_{5-w}X″_{w} (Vd),

wherein: 0<j<1 (e.g., 0.0001≤j≤0.9998); 0<y<3; 0<w<5; A′ and A″ are each a monovalent cation selected from the group comprising Tl, In, Li, Na, K, Rb, and Cs (optionally selected from the group comprising Li, Na, K, Rb, and Cs), and subject to the proviso that A′ and A″ are not the same; B′ and B″ are each a divalent cation selected from the group comprising Be, Mg, Ca, Sr, Ba, Zn, Cd, and Hg (optionally selected from the group comprising Be, Mg, Ca, Sr, and Ba), and subject to the proviso that B′ and B″ are not the same; and X′ and X″ are each a halide selected the group comprising F, Cl, Br, and I, subject to the proviso that X′ and X″ are not the same.

In some embodiments, A comprises Cs (e.g., one of A′ and A″ is Cs). In some embodiments, B comprises Mg (e.g., one of B′ and B″ is Mg). In some embodiments, X comprises at least one of F, Cl, and Br (e.g., one of X′ and X″ is F, Cl, or Br). In some embodiments X comprises Cl (e.g., one of X′ and X″ is Cl). In some embodiments, the composition of Formula (V) is Cs₃MgCl₅.

In some embodiments, the scintillator material comprises a composition of Formula (V) in addition to one or more composition of Formula (I), (II), (III), or (IV).

### III. Radiation Detectors and Related Methods

In some embodiments, the presently disclosed subject matter provides a radiation detector comprising a scintillator material comprising a composition of one of Formulas (I), (II), (III) (IV) and (V) (or a mixture of two or more of said compositions) and a photon detector. The scintillator material can absorb radiation and emit light and the photon detector can detect the emitted light. In some embodiments, the radiation detector comprises a scintillator material comprising a composition of one of Formulas (I), (II), (III) and (IV) (or a mixture of said compositions). In some embodiments the radiation detector comprises a scintillator material comprising a composition of one of Formula (I), (II), and (III) (or a mixture of said compositions).

The photodetector can be any suitable detector or detectors and can be or not be optically coupled to the scintillator material for producing an electrical signal in response to emission of light from the scintillator material. Thus, the photodetector can be configured to convert photons to an electrical signal. For example, a signal amplifier can be provided to convert an output signal from a photodiode into a voltage signal. The signal amplifier can also be designed to amplify the voltage signal. Electronics associated with the photodetector can be used to shape and digitize the electronic signal.

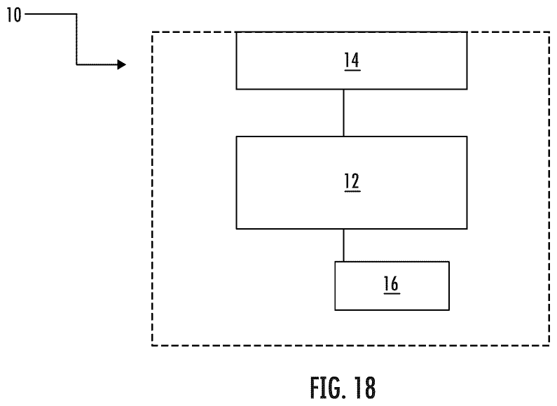

Referring now to FIG. 18, in some embodiments, the presently disclosed subject matter provides an apparatus 10 for detecting radiation wherein the apparatus comprises a photon detector 12 and a scintillator material 14 (e.g., an inorganic halide scintillator material). Scintillator material 14 can convert radiation to light that can be collected by a charge-coupled device (CCD) or a photomultiplier tube (PMT) or other photon detector 12 efficiently and at a fast rate.

Referring again to FIG. 18, photon detector 12 can be any suitable detector or detectors and can be optically coupled (e.g., via optical grease or another optical coupling compound, such as an optical coupling oil or liquid) to the scintillator (e.g., an inorganic halide scintillator material) for producing an electrical signal in response to emission of light from the scintillator. Thus, photon detector 12 can be configured to convert photons to an electrical signal. Electronics associated with photon detector 12 can be used to shape and digitize the electronic signal. Suitable photon detectors 12 include, but are not limited to, photomultiplier tubes, photodiodes, CCD sensors, and image intensifiers. Apparatus 10 can also include electronics 16 for recording and/or displaying the electronic signal.

In some embodiments, the radiation detector is configured for use as part of a medical or veterinary diagnostic device, a device for oil or other geological exploration (e.g., oil well logging probes), a device or instrument for surveying or as a device for security and/or military-related purposes (e.g., as a device for container, vehicle, or baggage scanning or for scanning humans or other animals), or a device or instrument for research (e.g., high energy physics (HEP) research). In some embodiments, the medical or veterinary diagnostic device is selected from, but not limited to, a hard X-ray imaging device, a positron emission tomography (PET) device (e.g., a TOF-PET device), an X-ray computed tomography (CT) device, a single photon emission computed tomography (SPECT) device, or a planar nuclear medical imaging device. For example, the radiation detector can be configured to move (e.g., via mechanical and/or electronic controls) over and/or around a sample, such as a human or animal subject, such that it can detect radiation emitted from any desired site or sites on the sample. In some embodiments, the detector can be set or mounted on a rotating body to rotate the detector around a sample.

In some embodiments, the device can also include a radiation source. For instance, an X-ray CT device of the presently disclosed subject matter can include an X-ray source for radiating X-rays and a detector for detecting said X-rays. In some embodiments, the device can comprise a plurality of radiation detectors. The plurality of radiation detectors can be arranged, for example, in a cylindrical or other desired shape, for detecting radiation emitted from various positions on the surface of a sample.

In some embodiments, the presently disclosed subject matter provides a method for detecting radiation (or the absence of radiation) using a radiation detector comprising a scintillator material as described hereinabove (e.g., a scintillator material comprising a composition of one of Formula (I), (II), (III) (IV) or (V) (or a mixture of said compositions)). Thus, in some embodiments, the presently disclosed subject matter provides a method of detecting gamma rays, X-rays, cosmic rays and/or particles having an energy of 1 keV or greater, wherein the method comprises using a radiation detector comprising a scintillator material comprising a composition of one of Formulas (I), (II), (III) (IV), or (V) (or a mixture of said compositions). In some embodiments, the radiation detector comprises a scintillator material comprising a composition of one of Formula (I), (II), (III) or (IV) (or a mixture of said compositions). In some embodiments the radiation detector comprises a scintillator material comprising a composition of one of Formula (I), (II), or (III) (or a mixture of said compositions). In some embodiments, the radiation detector is for use in PET (e.g., TOF-PET), hard X-ray imaging; or high energy physics (HEP) research.

Radiation detectors that can detect neutrons can be used, for example, to measure power in nuclear or research reactors; as research instruments in the fields of materials science, plasma physics, and particle physics; and to detect cosmic rays and/or special nuclear materials. In some embodiments, the radiation detector can be a medical diagnostic device, a device for oil exploration, a surveying device, or a device for container or baggage scanning. In some embodiments, the radiation detector can be a scientific research device.

In some embodiments, the presently disclosed methods can comprise providing a radiation detector comprising a photodetector and a scintillator material of the presently disclosed subject matter; positioning the detector, wherein the positioning comprises placing the detector in a location wherein the scintillator material is in the path of a beam of radiation (or the suspected path of a beam of radiation); and detecting light (or detecting the absence of light) emitted by the scintillator material with the photodetector. Detecting the light emitted by the scintillator material can comprise converting photons to an electrical signal. Detecting can also comprise processing the electrical signal to shape, digitize, or amplify the signal. The method can further comprise displaying the electrical signal or processed electrical signal.

### IV. Methods of Preparation

The presently disclosed compositions can be prepared via any suitable method as would be apparent to one of ordinary skill in the art upon a review of the instant disclosure. In some embodiments, the presently disclosed subject matter provides a method of preparing a scintillator material comprising a composition of one of Formulas (I), (II), (III), (IV) or (V). In some embodiments, the method comprises preparing a crystal (e.g., a single crystal having a composition of one of Formulas (I)-(V)) from a melt (i.e., a mixture of molten raw materials). For instance, in some embodiments, the composition can be prepared by the Bridgman method (e.g., the vertical Bridgman or Bridgman-Stockbarger method), wherein a crucible or ampoule containing a melt of the molten raw materials is pulled through a temperature gradient in a furnace from a warmer region of the furnace to a cooler region, causing the molten raw materials to slowly cool and a crystal or crystals to form. However, single crystals or polycrystalline materials and/or ceramics grown or produced by other methods can also be used as a scintillator material according to the present disclosure. For example, alternative methods for producing the presently disclosed compositions include, but are not limited to the micro-pulling down method, the Czochralski (pulling-up) method, zone melt method, Edge-defined Film-fed Growth (EFG) method, and hot isostatic press (HIP) sintering method.

Raw materials (i.e., “starting materials”) can include halides (e.g., binary halides), such as CsI, CsCl, MgCl₂, ZnCl₂, etc. In some embodiments, the starting materials include a ⁶Li enriched lithium compound. When the composition is used as a crystal for a scintillator, a high-purity raw material (e.g., having a purity of 99.99% or higher and/or not containing more than 1 ppm of an impurity) can be used. These starting materials can be weighed and mixed such that a desired composition is obtained at the time of forming a melt.

In some embodiments, the raw materials can be measured out and mixed, e.g., using a ball mill, etc., and the mixed powder heated to a temperature above the melting temperature of the raw material with the highest melting temperature to provide a homogenous mixture of raw materials and cooled.

In some embodiments, the presently disclosed materials can be provided as ceramics, for example, by using a hot press or hot isotatic press (HIP) method.

In some embodiments, the method further comprises annealing the composition of Formula (I)-(V) for a period of time (e.g., between a few hours and a few days). The annealing can be performed, for example, under vacuum, in nitrogen, or a mixture of nitrogen and hydrogen. The annealing can be done at any suitable temperature that is lower than the melting point of the material, e.g., between about 100 and about 800 degrees Celsius (e.g., about 100, 200, 300, 400, 500, 600, 700, or about 800 degrees Celsius). In some embodiments, the annealing increases the light yield of the material and/or provides a material with a faster scintillation decay time. In some embodiments, the annealing is performed under vacuum. In some embodiments, the annealing is performed at a temperature of about 500° C. and/or for a time period of about 48 hours.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### Example 1

Single crystals of undoped and 5 mol % Zn-doped Cs₂MgCl₄ and CsMgCl₃ were grown in 7 mm diameter quartz ampoules using the vertical Bridgman method. Prior to growth, raw materials in the form of binary halides (e.g., CsCl, MgCl₂, ZnCl₂) of 99.99% (4N) purity or higher were loaded into the ampoules inside a glovebox with nitrogen atmosphere. The ampoule was then connected to a vacuum system and the material was dried at room temperature for 12 hours, after which the ampoule was sealed with an oxygen-hydrogen torch. The compounds were formed by heating the charge to a temperature above the melting points of the individual constituents and soaking at this temperature for 12 hours. This step was performed twice to ensure full mixing.

Powder X-ray diffraction (XRD) data was collected at room temperature using a PANalytical Empyrean diffractometer (Malvern Panalytical, Malvern, United Kingdom) with the Bragg-Brentano geometry and theta-theta goniometer. Samples obtained from the grown crystals were crushed into powders and measured while encapsulated with a protective film sold under the tradename KAPTON™ (Dupont Electronics, Wilmington, Delaware) to prevent exposure to air. X-rays were generated with a Cu Kα source operated at 45 kV and 40 mA.

Radioluminescence was measured under excitation by a Cu target X-ray tube operated at 35 kV and 0.1 mA. Emission spectra were collected from 200 nm to 700 nm with a 150 mm focal length monochromator. To eliminate second order peaks in the range of 400-700 nm, spectra were also collected with a 385 nm longpass optical filter placed between the crystal and monochromator. The full spectra were then reconstructed from the data acquired with and without an optical filter.

Scintillation decay time was measured under excitation by a 662 keV ¹³⁷Cs source using the time-correlated single photon counting technique described by Bollinger and Thomas [10]. Pulse height spectra were collected using a ¹³⁷Cs source with a Hamamatsu R2059 photomultiplier tube (PMT) (Hamamatsu Photonics, K.K., Hamamatsu City, Japan) operated at 1.5 kV using a signal processing chain consisting of a Canberra 2005 preamplifier (Canberra Industries, Inc., Meridan, Connecticut, United States of America), an Ortec 672 amplifier (Advanced Measurement Technology, Inc., Oak Ridge, Tennessee, United States of America) set to shaping times of 0.5 μs to 10 μs, and a Tukan 8K multi-channel analyzer (National Center for Nuclear Research, Swierk, Poland). Absolute light yield was calculated as number of photons per MeV using the method described by Bertolaccini et al. [11], which compares the centroid of the 662 keV full energy photopeak to that of the single photoelectron (SPE) and accounts for the quantum efficiency (QE) of the PMT. Pulse height measurements were performed with the crystals covered or wrapped in sheets of reflective Teflon and coupled directly to the PMT with a thin layer of mineral oil.

### Results:

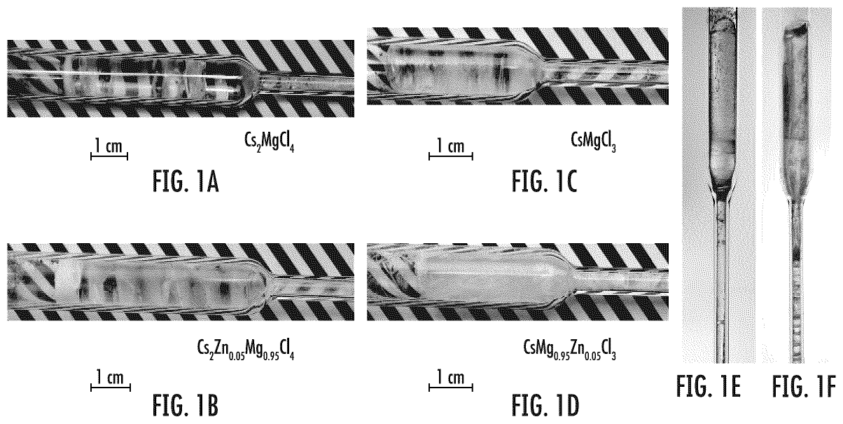

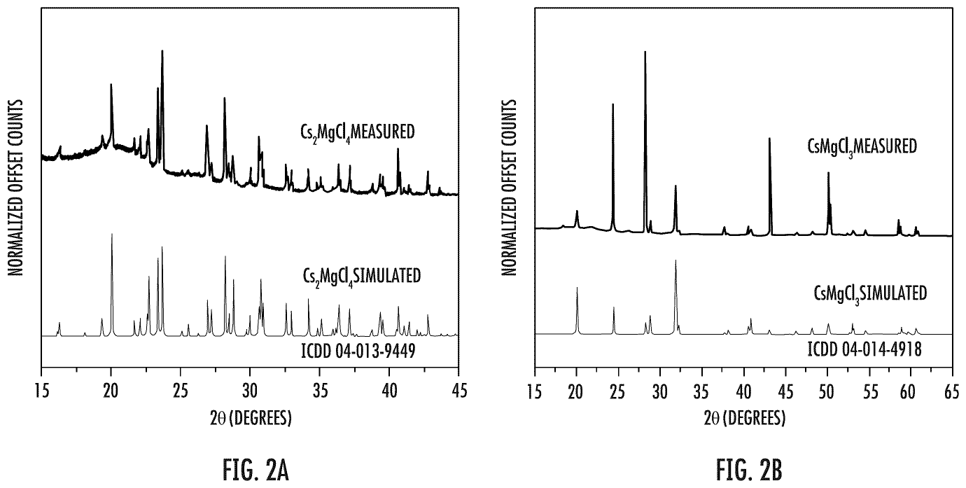

Structural and scintillation properties of undoped and Zn-doped Cs₂MgCl₄ and CsMgCl₃ were studied. Photographic images of the as-grown crystals can be seen in FIGS. 1A-1F. All crystals were transparent and colorless. Despite the hazy appearance on the surface of CsMg_{0.95}Zn_{0.05}Cl₃ (i.e. CsMgCl₃ doped with 5 mol % Zn), the bulk of the crystal was transparent. X-ray diffraction confirmed that the intended phases were obtained with each crystal. The measured diffraction patterns are shown in FIGS. 2A and 2B, along with simulated patterns. Cs₂MgCl₄ crystallizes in the orthorhombic Pnma space group. CsMgCl₃ crystallizes in the hexagonal P6₃/mmc space group. Without being bound to any one theory, it is believed that differences in intensities between the measured and simulated peaks of CsMgCl₃ are due to preferred orientation in the prepared powder.

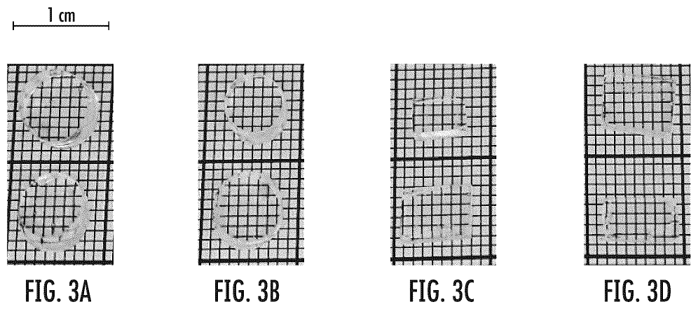

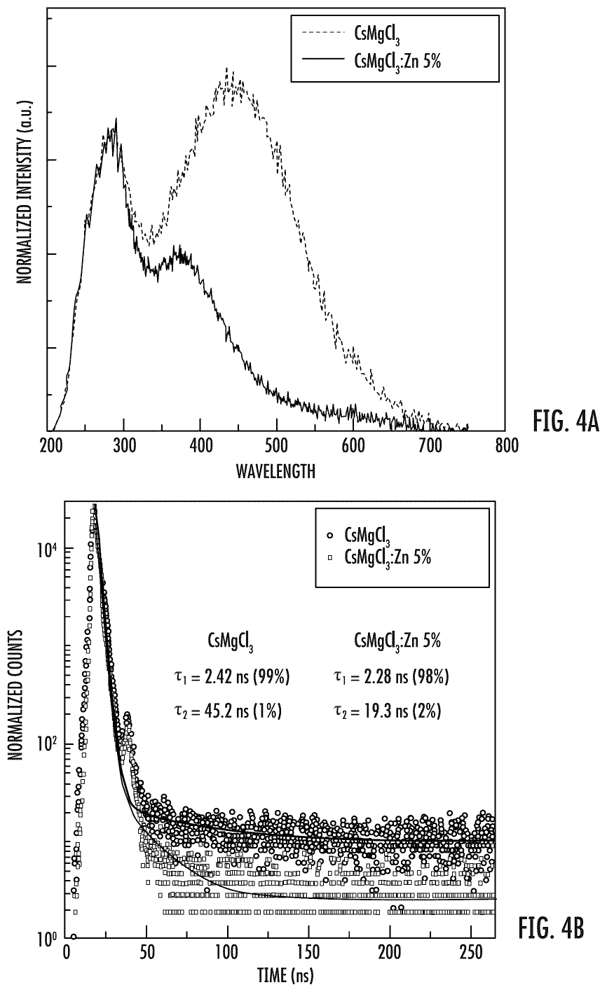

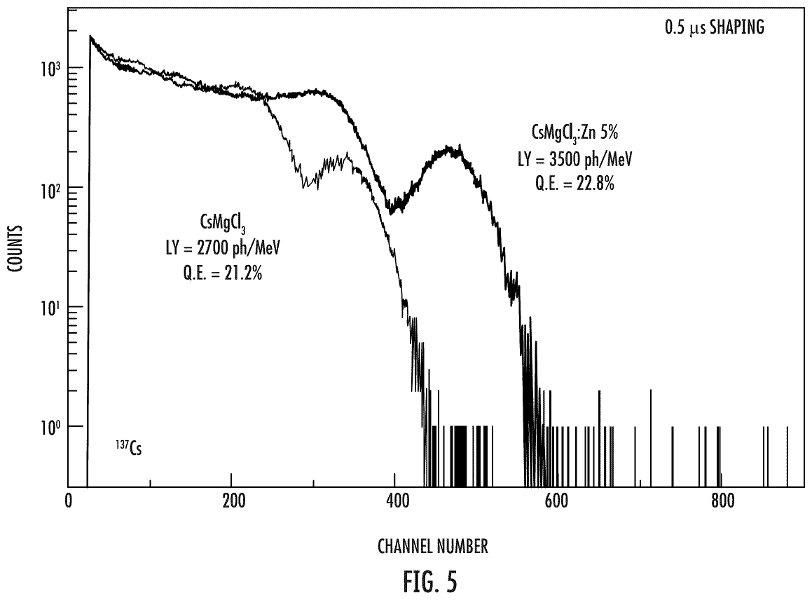

Characterization of scintillation properties was performed on smaller samples, approximately 2 mm to 4 mm thick, that were cleaved from the grown crystals and then polished. The samples used for these measurements are pictured in FIGS. 3A-3D. Radioluminescence emission spectra of undoped CsMgCl₃ and CsMg_{0.95}Zn_{0.05}Cl₃ are shown in FIG. 4A. Both have an emission band at 282 nm, whereas the spectra deviate at longer wavelengths. CsMgCl₃ has a broad emission band centered at 445 nm that is suppressed in the Zn-doped crystal. Instead, CsMg_{0.95}Zn_{0.05}Cl₃ features a narrower band at 369 nm. The scintillation decay times measured for undoped CsMgCl₃ and CsMg_{0.95}Zn_{0.05}Cl₃ are indicative of core valence luminescence and can be seen in FIG. 4B. The fast decay component accounts for ˜99% of the emission in both and improves from 2.42 ns to 2.28 ns upon doping with Zn. Pulse height spectra of undoped CsMgCl₃ and CsMg_{0.95}Zn_{0.05}Cl₃ from which light yield was calculated are shown in FIG. 5. The light yield improves from 2700 ph/MeV to 3500 ph/MeV (a ˜30% improvement) when doping CsMgCl₃ with 5 mol % Zn. The QE of the PMT across the emission wavelengths of the measured crystals was 21.2% for CsMgCl₃ and 22.8% for CsMg_{0.95}Zn_{0.05}Cl₃.

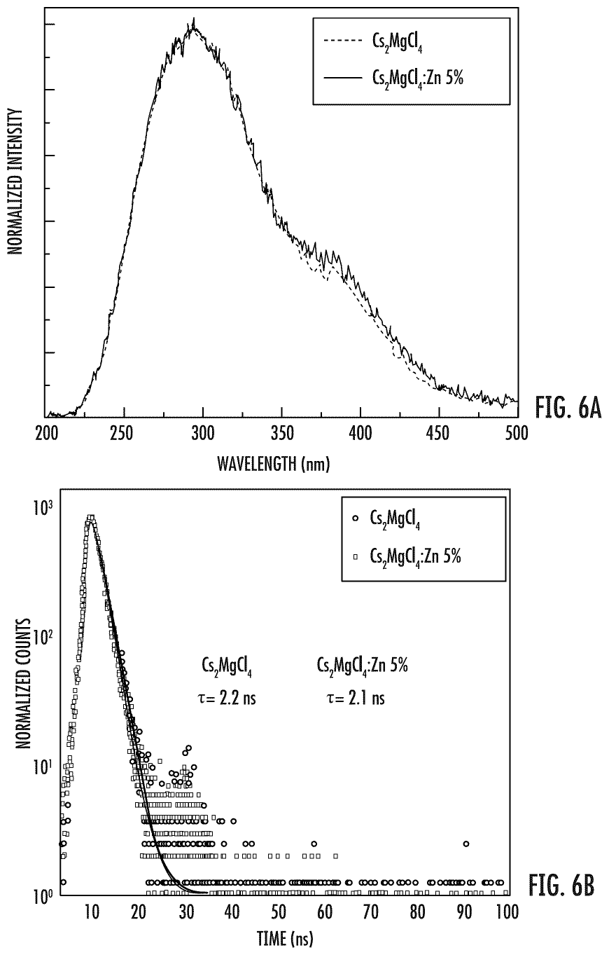

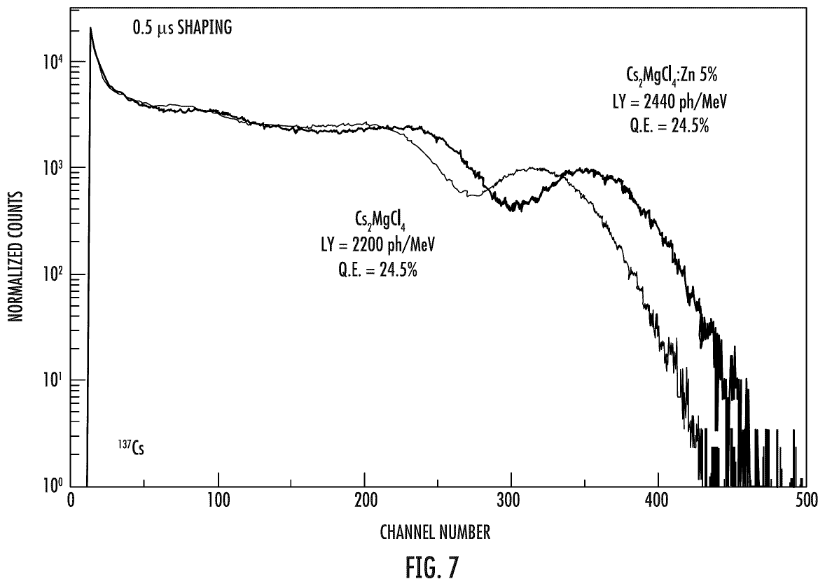

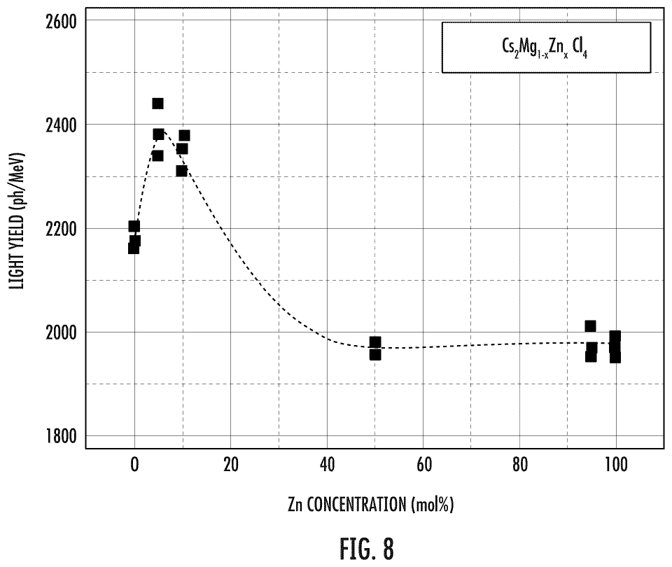

Radioluminescence emission spectra of Cs₂MgCl₄ and Cs₂Mg_{0.95}Zn_{0.05}Cl₄ are shown in FIG. 6A. The two compositions have nearly identical spectra, with bands at ˜294 nm and ˜378 nm. This is similar to what is observed for Cs₂ZnCl₄ in [9]. The scintillation decay time of Cs₂MgCl₄ does not change significantly when doping with Zn, as can be seen in FIG. 6B. Single component decay times around 2.1-2.2 ns are observed for both. Similar to what occurs with Zn-doped CsMgCl₃, the light yield of Cs₂MgCl₄ improves when doping with Zn. This is shown in FIG. 7. In this case, the light yield increases from 2200 ph/MeV for the undoped crystal to 2440 ph/MeV for the 5% Zn-doped crystal. A range of Zn concentrations were evaluated in Cs₂MgCl₄, and light yield improvements were observed with both 5% and 10% Zn, as can be seen in FIG. 8.

### Example 2

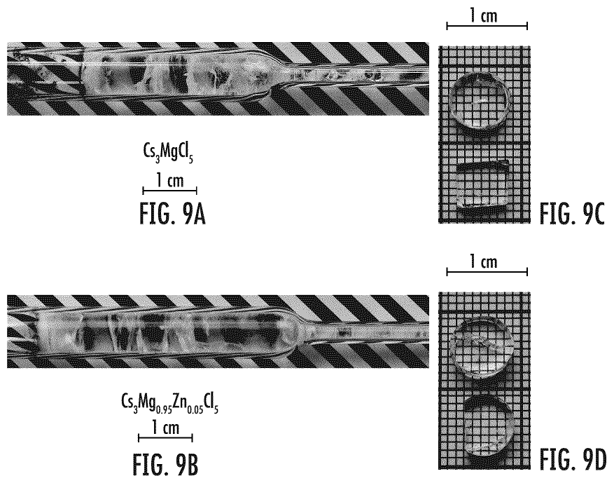

Single crystals of undoped and 5 mol % Zn-doped Cs₃MgCl₅ and Cs₃MgCl₅ were prepared according to a method analogous to that described in Example 1. Photographic images of as-grown 7 mm crystals are shown in FIGS. 9A and 9B. FIGS. 9C and 9D show images of cleaved pieces that were polished and used to study scintillation characteristics.

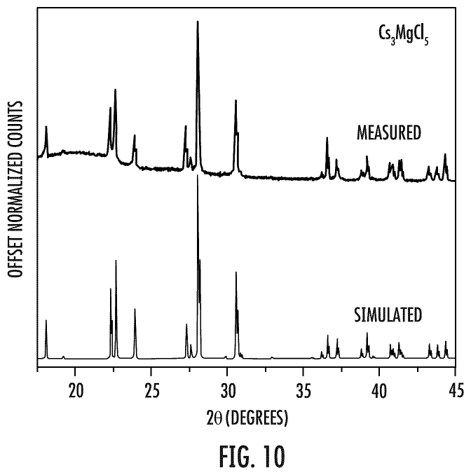

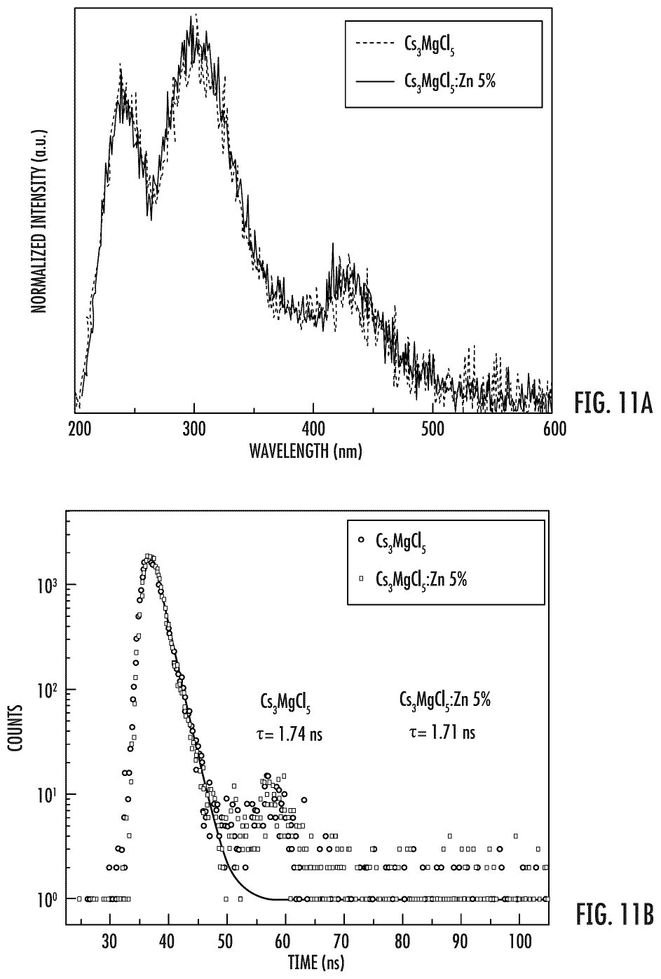

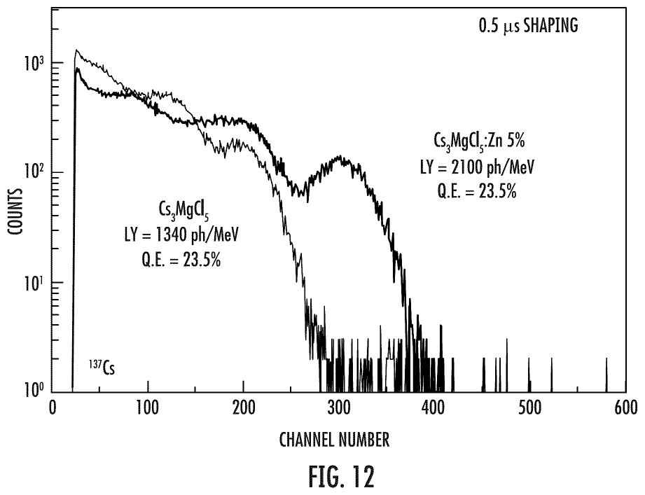

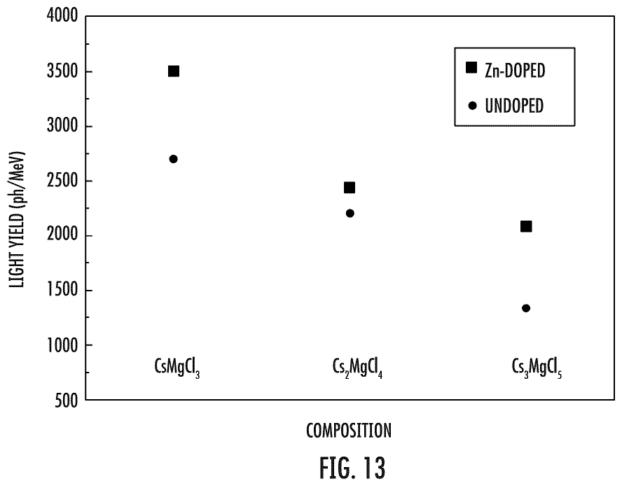

The measured room temperature X-ray diffraction pattern for Cs₃MgCl₅ is shown in FIG. 10, compared with a simulated reference pattern. FIGS. 11A and 11 B show the radioluminescence emission spectra and scintillation decay time, respectively, of undoped Cs₃MgCl₅ and Cs₃Mg_{0.95}Zn_{0.05}Cl₅. Decay time in FIG. 11B was fitted with a single exponential function (shown as solid lines) for each. FIG. 12 shows the pulse height spectra of undoped Cs₃MgCl₅ and Cs₃Mg_{0.95}Zn_{0.05}Cl₅ measured under excitation by a 662 keV ¹³⁷Cs source. The PMT QE values for the emission spectrum of each composition are also displayed. FIG. 13 shows the effect of Zn-doping on light yield for three scintillator compounds in the CsCl—MgCl₂ system: CsMgCl₃, Cs₂MgCl₄, and Cs₃MgCl₅. In all three, Zn doping improved light yield.

### Example 3

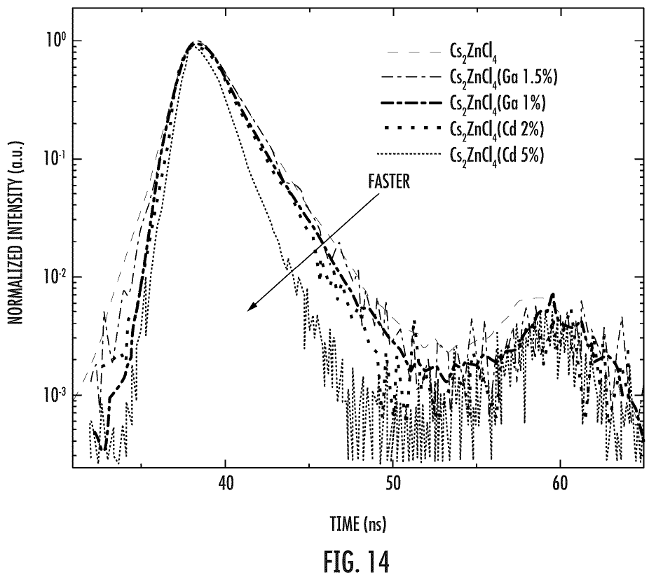

Compositions comprising Cs₂ZnCl₄ doped with 1 mol % or 1.5 mol % Ga or with 2 mol % or 5 mol % Cd were prepared according to a method analogous to that described in Example 1. The radioluminescence emission spectra of the undoped Cs₂ZnCl₄ and the Ga and Cd doped compositions are shown in FIG. 14.

### Example 4

Crystals comprising Cs₂ZnCl₄ doped with 1 mol % or 1.5 mol % Ga or doped with 2 mol % or 5 mol % Cd were prepared according to a method analogous to that described in Example 1. The radioluminescence emission spectra of the undoped Cs₂ZnCl₄ and the Ga and Cd doped compositions are shown in FIG. 14. LY and decay times for the compositions are summarized in Table 1, below. The percent change (increase) in LY of the doped composition compared to the undoped Cs₂ZnCl₄ is also shown in Table 1.

TABLE 1
Scintillation Light Yield and Decay Time of Cs₂ZnCl₄ Crystals

| | Light Yield | | |
|---|---|---|---|
| Composition | (ph/MeV) | Change (%) | Decay time |
| Cs₂ZnCl₄ | 2060 | — | 1.96 ns |
| Cs₂ZnCl₄ (Cd 2%) | 2360 | 14.6 | 1.63 ns |
| Cs₂ZnCl₄ (Cd 5%) | 2120 | 2.9 | 1.1 ns |
| Cs₂ZnCl₄ (Ga 1%) | 2430 | 17.9 | 1.95 ns |
| Cs₂ZnCl₄ (Ga 1.5%) | 2360 | 14.3 | 1.83 ns |

### Example 5

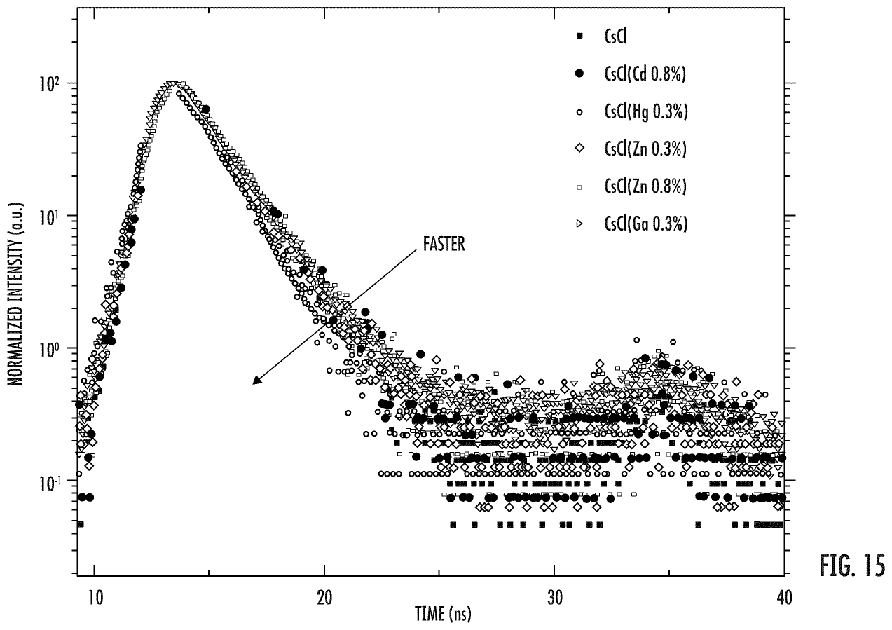

Crystals comprising CsCl doped with 0.3 mol % or 0.8 mol % Cd, Hg, Zn, and Ga were prepared according to a method analogous to that described in Example 1. The radioluminescence emission spectra of the undoped CsCl and the doped compositions are shown in FIG. 15. LY and decay times for the compositions are summarized in Table 2, below. The percent change (increase or decrease) in LY of the doped composition compared to the undoped CsCl is also shown in Table 2.

TABLE 2
Scintillation Light Yield and Decay Time of CsCl Crystals

| | Light Yield | | |
|---|---|---|---|
| Composition | (ph/MeV) | Change (%) | Decay time |
| CsCl | 2380 | — | 1.73 ns |
| CsCl (Cd 0.8%) | 2620 | 10.2 | 1.71 ns |
| CsCl (Ga 0.8%) | 2770 | 16.2 | 1.71 ns |
| CsCl (Hg 0.3%) | 1800 | (24.2) | 1.45 ns |
| CsCl (Zn 0.3%) | 2817 | 18.3 | 1.64 ns |
| CsCl (Zn 0.8%) | 2780 | 17.3 | 1.73 ns |

### Example 6

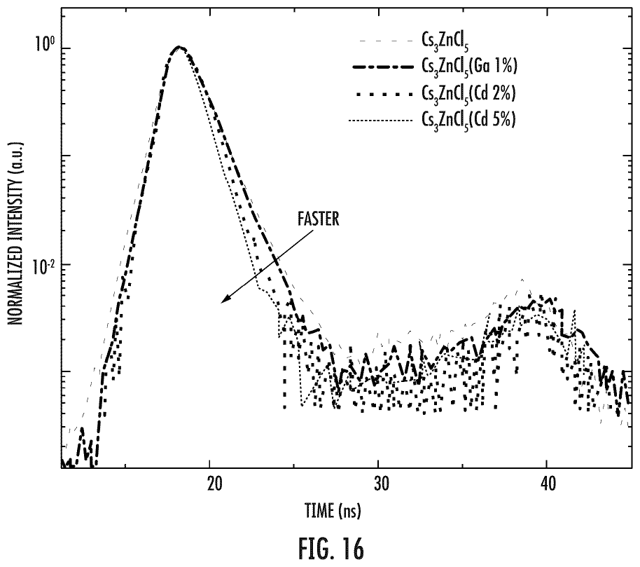

Crystals comprising Cs₃ZnCl₅ doped with 1 mol % or 1.5 mol % Ga or doped with 2 mol % or 5 mol % Cd were prepared according to a method analogous to that described in Example 1. The radioluminescence emission spectra of the undoped Cs₃ZnCl₅ and the Ga and Cd doped compositions are shown in FIG. 16. LY and decay times for the compositions are summarized in Table 3, below. The percent change (i.e., increase) in LY of the doped composition compared to the undoped Cs₃ZnCl₅ is also shown in Table 3.

TABLE 3
Scintillation Light Yield and Decay Time of Cs₃ZnCl₅ Crystals

| | Light Yield | | | |
|---|---|---|---|---|
| Composition | (ph/MeV) | Change (%) | Decay time | |
| Cs₃ZnCl₅ | 1340 | — | 1.2 | ns |
| Cs₃ZnCl₅ (Cd 2%) | 1570 | 17.2 | 0.95 | ns |
| Cs₃ZnCl₅ (Cd 5%) | 1510 | 12.2 | 0.87 | ns |
| Cs₃ZnCl₅ (Ga 1%) | 1440 | 7.2 | 1.1 | ns |
| Cs₃ZnCl₅ (Ga 1.5%) | 1450 | 8.3 | 1.0 | ns |

### Example 7

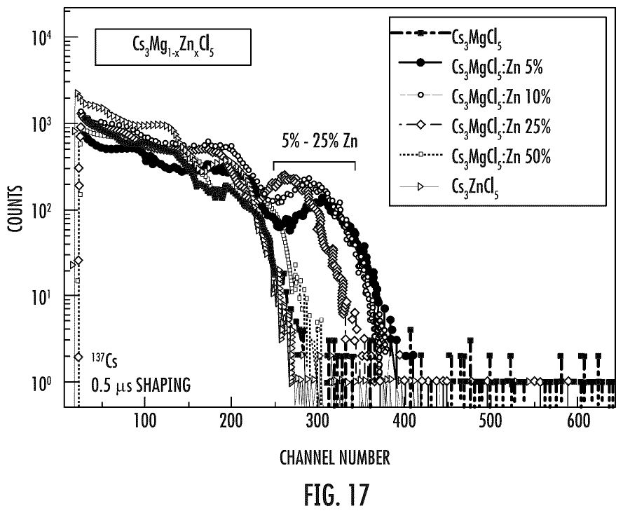

Single crystals were prepared of Cs₃MgCl₅ doped with different amounts of Zn from 5 mol % to 50 mol %. The pulse height spectra for undoped and doped Cs₃MgCl₅ compositions, as well as of a Cs₃ZnCl₅ composition, are shown in FIG. 17. Light yields are summarized in Table 4. Improved light yield was observed with doping, particularly in the 5 mol % to 25 mol % Zn range.

TABLE 4
Light Yield of Cs₃Mg₁₋ₓZnₓCl₅
Crystals as a Function of Zn Concentration.

| Zn Concentration (mol %) | Light Yield (ph/MeV) |
|---|---|
| 0 | 1340 |
| 5 | 2180 |
| 10 | 2100 |
| 25 | 1950 |
| 50 | 1580 |
| 100 | 1460 |

### REFERENCES

The references listed below as well as all references cited in the specification including, but not limited to patents, patent application publications, and journal articles are incorporated herein by reference to the extent that they supplement, explain, provide a background for, or teach methodology, techniques, and/or compositions employed herein.
[1] P. A. Rodnyi and M. A. Terekhin, “Radiative Core-Valence Transitions in Alkali-Halide Crystals,” physica status solidi (b), vol. 166, no. 1, pp. 283-288, (1991), doi: 10.1016/0167-5087(83)91254-1.
[2] A. P. Shpak, O. A. Glike, A. G. Dmitriev, P. A. Rodnyi, A. S. Voloshinovskii, and S. M. Pidzyrailo, “Radiative core-valence transitions in wide-gap crystals,” Journal of Electron Spectroscopy and Related Phenomena, vol. 68, pp. 335-338, (1994), doi: 10.1016/0368-2048(94)02131-7.
[3] M. A. Macdonald, E. N. Mel'chakov, I. H. Munro, P. A. Rodnyi, and A. S. Voloshinovsky, “Radiative core-valence transitions in CsMgCl₃ and CsSrCl₃,” Journal of Luminescence, vol. 65, no. 1, pp. 19-23, (1995), doi: 10.1016/0022-2313(95)00051-Q.
[4] V. Vaněček et al., “(INVITED) Ultraviolet cross-luminescence in ternary chlorides of alkali and alkaline-earth metals,” Optical Materials: X, vol. 12, p. 100103, (2021), doi: 10.1016/j.omx.2021.100103.
[5] M. Koshimizu, N. Yahaba, R. Haruki, F. Nishikido, S. Kishimoto, and K. Asai, “Scintillation and luminescence properties of a single CsCaCl₃ crystal,” Optical Materials, vol. 36, no. 12, pp. 1930-1933, (2014), doi: 10.1016/j.opt,at.2014.04.004.
[6] K. Takahashi, M. Arai, M. Koshimizu, Y. Fujimoto, T. Yanagida, and K. Asai, “Luminescence characteristics of Cs₂BaCl₄,” Japanese Journal of Applied Physics, vol. 59, no. 3, p. 032003, (2020), doi: 10.35848/1347-4065/ab762b.
[7] K. Takahashi, M. Arai, M. Koshimizu, Y. Fujimoto, T. Yanagida, and K. Asai, “Luminescence and scintillation properties of Cs₂ZnCl₄ and Cs₃ZnCl₅,” Japanese Journal of Applied Physics, vol. 59, no. 7, p. 072002, (2020), doi: 10.35848/1347-4065/ab9655.
[8] A. Ohnishi, M. Kitaura, T. Otomo, and M. Sasaki, “Reflection Spectrum and Auger-Free Luminescence in Molecular Ionic Crystals of Cs₂ZnCl₄,” Journal of the Physical Society of Japan, vol. 72, no. 9, pp. 2400-2401, (2003), doi: 10.1143/JPSJ.72.2400.
[9] N. Yahaba et al., “X-ray detection capability of a Cs₂ZnCl₄ single-crystal scintillator,” Applied Physics Express, vol. 7, no. 6, p. 062602, (2014), doi: 10.7567/apex.7.062602.
[10] Bollinger and Thomas, Review of Scientific Instruments, Vol. 32, 1044-1050 (1961).
[11] M. Bertolaccini, S. Cova, and C. Bussolatti, “A Technique for Absolute Measurement of the Effective Photoelectron per keV Yield in Scinitillation Counters” in Proc. Nuclear Electronics Symp., Societe Francaise des Electroniciens et des Radioelectriciens, Versailles, France, 1968.
[12] U.S. Pat. No. 9,624,429B2.
[13] U.S. Pat. No. 10,591,617B2.
[14] U.S. Pat. No. 11,249,202B2.
[15] U.S. Pat. No. 10,125,312B2.
[16] U.S. Patent Application Publication No. 2022/0025257A1.
[17] U.S. Patent Application Publication No. 2021/0125790A1.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A scintillator material comprising a composition of one of Formulas (I), (II), (III) or (IV):
A₂B₁₋ᵢX₄:Dᵢ, (I),
AB₁₋ᵢX₃:Dᵢ, (II),
A₁₋ᵢX:Dᵢ, (III), or
A₃B₁₋ᵢX₅:Dᵢ, (IV);
wherein:
0.0001≤i≤0.9999;
A is one or more monovalent cations selected from the group consisting of Tl, In, Li, Na, K, Rb, and Cs;
B is one or more divalent cations selected from the group consisting of Be, Mg, Ca, Sr, Ba, Zn, Cd, and Hg;
X is one or more halides selected from the group consisting of F, Cl, Br, and I, subject to the proviso that when the scintillator material comprises a composition of Formula (III), X comprises at least one halide of the group consisting of F, Cl, and Br; and
D is one or more dopant ions selected from the group consisting of Zn, Cd, Hg, Cu, Mn, and Ga, subject to the proviso that D is not the same as B.

2. A scintillator material of claim 1, wherein the scintillator material comprises a composition of Formula (I):
A₂B₁₋ᵢX₄:Dᵢ, (I),
wherein:
0.0001≤i≤0.9999;
A is one or more monovalent cations selected from the group consisting of Tl, In, Li, Na, K, Rb, and Cs;
B is one or more divalent cations selected from the group consisting of Be, Mg, Ca, Sr, Ba, Zn, Cd, and Hg;
X is one or more halides selected from the group consisting of F, Cl, Br, and I; and
D is one or more dopant ions selected from the group consisting of Zn, Cd, Hg, Cu, Mn, and Ga, subject to the proviso that D is not the same as B.

3. The scintillator material of claim 2, wherein B comprises at least two different divalent cations, optionally wherein the composition of Formula (I) is a composition of Formula (Ia):
A₂B′₁₋ⱼB″ⱼX₄:Dᵢ (Ia),
wherein:
0.0001≤i≤0.9999;
0.0001≤j≤0.9998;
A is one or more monovalent cations selected from the group consisting of Tl, In, Li, Na, K, Rb, and Cs;
B′ and B″ are each a divalent cation selected from the group consisting of Be, Mg, Ca, Sr, Ba, Zn, Cd, and Hg, optionally Be, Mg, Ca, Sr, and Ba, subject to the proviso that B′ and B″ are not the same;
X is one or more halides selected from the group consisting of F, Cl, Br, and I; and
D is one or more dopant ions selected from the group consisting of Zn, Cd, Hg, Cu, Mn, and Ga, subject to the proviso that D is not the same as B′ or B″.

4. The scintillator material of claim 2, wherein A comprises at least two different monovalent cations, optionally wherein the composition of Formula (I) is a composition of Formula (Ib):
A′_{2-y}A″_{y}B₁₋ᵢX₄:Dᵢ (Ib),
wherein:
0.0001≤i≤0.9999;
0<y<2;
A′ and A″ are each a monovalent cation selected from the group consisting of Tl, In, Li, Na, K, Rb, and Cs, subject to the proviso that A′ and A″ are not the same;
B is one or more divalent cations selected from the group consisting of Be, Mg, Ca, Sr, Ba, Zn, Cd, and Hg, optionally Be, Mg, Ca, Sr, and Ba;
X is one or more halide selected from the group consisting of F, Cl, Br, and I; and
D is one or more dopant ions selected from the group consisting of Zn, Cd, Hg, Cu, Mn, and Ga, subject to the proviso that D is not the same as B.

5. The scintillator material of claim 2, wherein X comprises at least two different halides, optionally wherein the composition of Formula (I) is a composition of Formula (Ic):
A₂B₁₋ᵢX′_{4-w}X″_{w}:Dᵢ (Ic),
wherein:
0.0001≤i≤0.9999;
0<w<4;
A is one or more monovalent cations selected from the group consisting of Tl, In, Li, Na, K, Rb, and Cs;
B is one or more divalent cations selected from the group consisting of Be, Mg, Ca, Sr, Ba, Zn, Cd, and Hg, optionally Be, Mg, Ca, Sr, and Ba;
X′ and X″ are each a halide selected the group consisting of F, Cl, Br, and I, subject to the proviso that X′ and X″ are not the same; and
D is one or more dopant ions selected from the group consisting of Zn, Cd, Hg, Cu, Mn, and Ga, subject to the proviso that D is not the same as B.

6. The scintillator material of claim 2, wherein A comprises at least two different monovalent cations, B comprises at least two different divalent cations, and X comprises at least two different halides, optionally wherein the composition of Formula (I) is a composition of Formula (Id):
A′_{2-y}A″_{y}B′₁₋ᵢ₋ⱼB″ⱼX′_{4-w}X″_{w}:Dᵢ (Id),
wherein:
0.0001≤i≤0.9999;
0.0001≤j≤0.9998;
0<y<2;
0<w<4;
A′ and A″ are each a monovalent cation selected from the group consisting of Tl, In, Li, Na, K, Rb, and Cs, subject to the proviso that A′ and A″ are not the same;
B′ and B″ are each a divalent cation selected from the group consisting of Be, Mg, Ca, Sr, Ba, Zn, Cd, and Hg, optionally Be, Mg, Ca, Sr, and Ba, subject to the proviso that B′ and B″ are not the same;
X′ and X″ are each a halide selected the group consisting of F, Cl, Br, and I, subject to the proviso that X′ and X″ are not the same; and
D is one or more dopant ions selected from the group consisting of Zn, Cd, Hg, Cu, Mn, and Ga, subject to the proviso that D is not the same as B′ or B″.

7. The scintillator material of claim 2, wherein D comprises at least two dopant ions selected from the group consisting of Zn, Cd, Hg, Cu, Mn, and Ga.

8. The scintillator material of claim 2, wherein A comprises Cs or wherein one of A′ and A″ is Cs.

9. The scintillator material of claim 2, wherein B comprises Mg or wherein one of B′ and B″ is Mg or Zn.

10. The scintillator material of claim 2, wherein X comprises at least one of F, Cl, or Br, optionally wherein X comprises Cl.

11. The scintillator material of claim 2, wherein D comprises Zn, Ga, or Cd.

12. The scintillator material of claim 2, wherein 0.005≤i≤0.20, optionally 0.05≤i≤0.10.

13. The scintillator material of claim 2, wherein the composition of Formula (I) is selected from the group consisting of Cs₂Mg_{0.95}Zn_{0.05}Cl₄, Cs₂Mg_{0.90}Zn_{0.1}Cl₄, Cs₂Zn_{0.99}Ga_{0.01}Cl₄, Cs₂Zn_{0.985}Ga_{0.015}Cl₄, Cs₂Zn_{0.98}Cd_{0.02}Cl₄, and CS₂Zn_{0.95}Cd_{0.05}Cl₄.

14. The scintillator material of claim 1, wherein the scintillator material comprises a composition of Formula (II):
AB₁₋ᵢX₃:Dᵢ (II),
wherein:
0.0001≤i≤0.9999;
A is one or more monovalent cations selected from the group consisting of Tl, In, Li, Na, K, Rb, and Cs;
B is one or more divalent cations selected from the group consisting of Be, Mg, Ca, Sr, Ba, Zn, Cd and Hg, optionally one or more of Be, Mg, Ca, Sr, and Ba;
X is one or more halides selected from the group consisting of F, Cl, Br, and I; and
D is one or more dopant ions selected from the group consisting of Zn, Cd, Hg, Cu, Mn, and Ga, subject to the proviso that D is not the same as B.

15. The scintillator material of claim 14, wherein B comprises at least two different divalent cations, optionally wherein the composition of Formula (II) is a composition of Formula (hla):
AB′₁₋ᵢ₋ⱼB″ⱼX₃:Dᵢ (IIa),
wherein:
0.0001≤i≤0.9999;
0.0001≤j≤0.9998;
A is one or more monovalent cations selected from the group consisting of Tl, In, Li, Na, K, Rb, and Cs;
B′ and B″ are each a divalent cation selected from the group consisting of Be, Mg, Ca, Sr, Ba, Zn, Cd, and Hg, optionally Be, Mg, Ca, Sr, and Ba, subject to the proviso that B′ and B″ are not the same;
X is one or more halides selected from the group consisting of F, Cl, Br, and I; and
D is one or more dopant ions selected from the group consisting of Zn, Cd, Hg, Cu, Mn, and Ga, subject to the proviso that D is not the same as B′ or B″.

16. The scintillator material of claim 14, wherein A comprises at least two different monovalent cations, optionally wherein the composition of Formula (II) is a composition of Formula (IIb):
A′_{1-y}A″_{y}B₁₋ᵢX₃:Dᵢ (IIb),
wherein:
0.0001≤i≤0.9999;
0<y<1;
A′ and A″ are each a monovalent cation selected from the group consisting of Tl, In, Li, Na, K, Rb, and Cs, subject to the proviso that A′ and A″ are not the same;
B is one or more divalent cations selected from the group consisting of Be, Mg, Ca, Sr, Ba, Zn, Cd, and Hg, optionally Be, Mg, Ca, Sr, and Ba;
X is one or more halides selected from the group consisting of F, Cl, Br, and I; and
D is one or more dopant ions selected from the group consisting of Zn, Cd, Hg, Cu, Mn, and Ga, subject to the proviso that D is not the same as B.

17. The scintillator material of claim 14, wherein X comprises at least two different halides, optionally wherein the composition of Formula (II) is a composition of Formula (IIc):
AB₁₋ᵢX′_{3-w}X″_{w}:Dᵢ (IIc),
wherein:
0.0001≤i≤0.9999;
0<w<3;
A is one or more monovalent cations selected from the group consisting of Tl, In, Li, Na, K, Rb, and Cs;
B is one or more divalent cations selected from the group consisting of Be, Mg, Ca, Sr, Ba, Zn, Cd, and Hg, optionally Be, Mg, Ca, Sr, and Ba;
X′ and X″ are each a halide selected the group consisting of F, Cl, Br, and I, subject to the proviso that X′ and X″ are not the same; and
D is one or more dopant ions selected from the group consisting of Zn, Cd, Hg, Cu, Mn, and Ga, subject to the proviso that D is not the same as B.

18. The scintillator material of claim 14, wherein A comprises at least two different monovalent cations, B comprises at least two different divalent cations, and X comprises at least two different halides, optionally wherein the composition of Formula (II) is a composition of Formula (lId):
A′_{1-y}A″_{y}B′₁₋ᵢ₋ⱼB″ⱼX′_{3-w}X″_{w}:Dᵢ (IId),
wherein:
0.0001≤i≤0.9999;
0.0001≤j≤0.9998;
0<y<1;
0<w<3;
A′ and A″ are each a monovalent cation selected from the group consisting of Tl, In, Li, Na, K, Rb, and Cs, subject to the proviso that A′ and A″ are not the same;
B′ and B″ are each a divalent cation selected from the group consisting of Be, Mg, Ca, Sr, Ba, Zn, Cd, and Hg, optionally Be, Mg, Ca, Sr, and Ba, subject to the proviso that B′ and B″ are not the same;
X′ and X″ are each a halide selected the group consisting of F, Cl, Br, and I, subject to the proviso that X′ and X″ are not the same; and
D is one or more dopant ion selected from the group consisting of Zn, Cd, Hg, Cu, Mn, and Ga, subject to the proviso that D is not the same as B′ or B″.

19. The scintillator material of claim 14, wherein D comprises at least two dopant ions selected from the group consisting of Zn, Cd, Hg, and Ga.

20. The scintillator material of claim 14, wherein A comprises Cs or wherein one of A′ and A″ is Cs.

21. The scintillator material of claim 14, wherein B comprises Mg or wherein one of B′ and B″ is Mg.

22. The scintillator material of claim 14, wherein X comprises at least one of F, Cl, or Br, optionally wherein X comprises Cl.

23. The scintillator material of claim 14, wherein D comprises Zn.

24. The scintillator material of claim 14, wherein 0.005≤i≤0.20, optionally 0.05≤i≤0.10.

25. The scintillator material of claim 14, wherein the composition of Formula (II) is CsMg_{0.95}Zn_{0.05}Cl₃.

26. The scintillator material of claim 1, wherein the scintillator material comprises a composition of Formula (III):
A₁₋ᵢX:Dᵢ (III),
wherein:
0.0001≤i≤0.9999;
A is one or more monovalent cations selected from the group consisting of Tl, In, Li, Na, K, Rb, and Cs;
X is one or more halides selected from the group consisting of F, Cl, Br, and I, subject to the proviso that X comprises at least one of the group consisting of F, Cl, and Br; and
D is one or more dopant ions selected from the group consisting of Zn, Cd, Hg, Cu, Mn, and Ga.

27. The scintillator material of claim 26, wherein A comprises at least two different monovalent cations, optionally wherein the composition of Formula (III) is a composition of Formula (IIIa):
A′_{1-i-y}A″_{y}X:Dᵢ (IIIa),
wherein:
0.0001≤i≤0.9999;
0.0001<y<0.9998;
A′ and A″ are each a monovalent cation selected from the group consisting of Tl, In, Li, Na, K, Rb, and Cs, subject to the proviso that A′ and A″ are not the same;
X is one or more halides selected from the group consisting of F, Cl, Br, and I, subject to the proviso that X comprises at least one of the group consisting of F, Cl, and Br; and
D is one or more dopant ions selected from the group consisting of Zn, Cd, Hg, Cu, Mn, and Ga.

28. The scintillator material of claim 26, wherein X comprises at least two different halides, optionally wherein the composition of Formula (III) is a composition of Formula (IIIb):
A₁₋ᵢX′_{1-w}X″_{w}Dᵢ (IIIb),
wherein:
0.0001≤i≤0.9999;
0<w<1;
A is one or more monovalent cations selected from the group consisting of Tl, In, Li, Na, K, Rb, and Cs;
X′ and X″ are each a halide selected the group consisting of F, Cl, Br, and I, subject to the proviso that X′ and X″ are not the same; and
D is one or more dopant ion selected from the group consisting of Zn, Cd, Hg, Cu, Mn, and Ga.

29. The scintillator material of claim 26, wherein A comprises at least two different monovalent cations and X comprises at least two different halides, optionally wherein the composition of Formula (III) is a composition of Formula (IIIc):
A′_{1-i-y}A″_{y}X′_{1-w}X″_{w}:Dᵢ (IIIc),
wherein:
0.0001≤i≤0.9999;
0.0001≤y≤0.9998;
0<w<1;
A′ and A″ are each a monovalent cation selected from the group consisting of Tl, In, Li, Na, K, Rb, and Cs, subject to the proviso that A′ and A″ are not the same;
X′ and X″ are each a halide selected the group consisting of F, Cl, Br, and I, subject to the proviso that X′ and X″ are not the same; and
D is one or more dopant ions selected from the group consisting of Zn, Cd, Hg, Cu, Mn, and Ga.

30. The scintillator material of claim 26, wherein the scintillator material comprises more than 5 weight % Zn or less than 0.5 wt % Zn.

31. The scintillator material of claim 26, wherein the scintillator material is selected from the group consisting of Cs_{0.997}Zn_{0.003}Cl, Cs_{0.992}Zn_{0.008}Cl, Cs_{0.997}Hg_{0.003}Cl, Cs_{0.997}Ga_{0.003}Cl, and Cs_{0.992}Cd_{0.008}Cl.

32. The scintillator material of claim 1, wherein the scintillator material comprises a composition of Formula (IV):
A₃B₁₋ᵢX₅:Dᵢ, (IV);
wherein:
0.0001≤i≤0.9999;
A is one or more monovalent cations selected from the group consisting of Tl, In, Li, Na, K, Rb, and Cs;
B is one or more divalent cations selected from the group consisting of Be, Mg, Ca, Sr, Ba, Zn, Cd and Hg, optionally one or more of Be, Mg, Ca, Sr, and Ba;
X is one or more halides selected from the group consisting of F, Cl, Br, and I; and
D is one or more dopant ions selected from the group consisting of Zn, Cd, Hg, Cu, Mn, and Ga, subject to the proviso that D is not the same as B.

33. The scintillator material of claim 32, wherein B comprises at least two different divalent cations, optionally wherein the composition of Formula (IV) is a composition of Formula (IVa):
A₃B′₁₋ᵢ₋ⱼB″ⱼX₅:Dᵢ (IVa),
wherein:
0.0001≤i≤0.9999;
0.0001≤j≤0.9998;
A is one or more monovalent cations selected from the group consisting of Tl, In, Li, Na, K, Rb, and Cs;
B′ and B″ are each a divalent cation selected from the group consisting of Be, Mg, Ca, Sr, Ba, Zn, Cd, and Hg, optionally Be, Mg, Ca, Sr, and Ba, subject to the proviso that B′ and B″ are not the same;
X is one or more halides selected from the group consisting of F, Cl, Br, and I; and
D is one or more dopant ions selected from the group consisting of Zn, Cd, Hg, Cu, Mn, and Ga, subject to the proviso that D is not the same as B′ or B″.

34. The scintillator material of claim 32, wherein A comprises at least two different monovalent cations, optionally wherein the composition of Formula (IV) is a composition of Formula (IVb):
A′_{3-y}A″_{y}B₁₋ᵢX₅:Dᵢ (IVb),
wherein:
0.0001≤i≤0.9999;
0<y<3;
A′ and A″ are each a monovalent cation selected from the group consisting of Tl, In, Li, Na, K, Rb, and Cs, subject to the proviso that A′ and A″ are not the same;
B is one or more divalent cations selected from the group consisting of Be, Mg, Ca, Sr, Ba, Zn, Cd, and Hg, optionally Be, Mg, Ca, Sr, and Ba;
X is one or more halides selected from the group consisting of F, Cl, Br, and I; and
D is one or more dopant ions selected from the group consisting of Zn, Cd, Hg, Cu, Mn, and Ga, subject to the proviso that D is not the same as B.

35. The scintillator material of claim 32, wherein X comprises at least two different halides, optionally wherein the composition of Formula (IV) is a composition of Formula (IVc):
A₃B₁₋ᵢX′_{5-w}X″_{w}:Dᵢ (IVc),
wherein:
0.0001≤i≤0.9999;
0<w<5;
A is one or more monovalent cations selected from the group consisting of Tl, In, Li, Na, K, Rb, and Cs;
B is one or more divalent cations selected from the group consisting of Be, Mg, Ca, Sr, Ba, Zn, Cd, and Hg, optionally Be, Mg, Ca, Sr, and Ba;
X′ and X″ are each a halide selected the group consisting of F, Cl, Br, and I, subject to the proviso that X′ and X″ are not the same; and
D is one or more dopant ions selected from the group consisting of Zn, Cd, Hg, Cu, Mn, and Ga, subject to the proviso that D is not the same as B.

36. The scintillator material of claim 32, wherein A comprises at least two different monovalent cations, B comprises at least two different divalent cations, and X comprises at least two different halides, optionally wherein the composition of Formula (IV) is a composition of Formula (IVd):
A′_{3-y}A″_{y}B′₁₋ᵢ₋ⱼ B″ⱼX′_{5-w}X″_{w}:Dᵢ (IVd),
wherein:
0.0001≤i≤0.9999;
0.0001≤j≤0.9998;
0<y<3;
0<w<5;
A′ and A″ are each a monovalent cation selected from the group consisting of Tl, In, Li, Na, K, Rb, and Cs, subject to the proviso that A′ and A″ are not the same;
B′ and B″ are each a divalent cation selected from the group consisting of Be, Mg, Ca, Sr, Ba, Zn, Cd, and Hg, optionally Be, Mg, Ca, Sr, and Ba, subject to the proviso that B′ and B″ are not the same;
X′ and X″ are each a halide selected the group consisting of F, Cl, Br, and I, subject to the proviso that X′ and X″ are not the same; and
D is one or more dopant ion selected from the group consisting of Zn, Cd, Hg, Cu, Mn, and Ga, subject to the proviso that D is not the same as B′ or B″.

37. The scintillator material of claim 32, wherein D comprises at least two dopant ions selected from the group consisting of Zn, Cd, Hg, Cu, Mn, and Ga.

38. The scintillator material of claim 32, wherein A comprises Cs or wherein one of A′ and A″ is Cs.

39. The scintillator material of 32, wherein B comprises Mg or Zn or wherein one of B′ and B″ is Mg or Zn.

40. The scintillator material of claim 32, wherein X comprises at least one of F, Cl, or Br, optionally wherein X comprises Cl.

41. The scintillator material of claim 32, wherein D comprises Zn, Ga, or Cd.

42. The scintillator material of claim 32, wherein 0.01≤i≤0.25.

43. The scintillator material of claim 32, wherein the composition of Formula (IV) is selected from the group consisting of Cs₃Mg_{0.95}Zn_{0.05}Cl₅, Cs₃Mg_{0.90}Zn_{0.1}Cl₅, Cs₃Mg_{0.75}Zn_{0.25}Cl₅, Cs₃Mg_{0.50}Zn_{0.5}Cl₅, Cs₃Zn_{0.95}Cd_{0.05}Cl₅, Cs₃Zn_{0.98}Cd_{0.02}Cl₅, Cs₃Zn_{0.985}Ga_{0.015}Cl₅, and Cs₃Zn_{0.99}Ga_{0.01}Cl₅.

44. The scintillator material of claim 1, wherein the scintillator material has increased light yield, shorter decay time, and/or improved timing resolution compared to a corresponding scintillator material where D is absent.

45. A scintillator material comprising a composition of Formula (V):
A₃BX₅ (V),
wherein:
A is one or more monovalent cations selected from the group consisting of Tl, In, Li, Na, K, Rb, and Cs;
B is one or more divalent cations selected from the group consisting of Be, Mg, Ca, Sr, Ba, Zn, Cd and Hg; and
X is one or more halides selected from the group consisting of F, Cl, Br, and I.

46. The scintillator material of claim 45, wherein A is Cs.

47. The scintillator material of claim 45, wherein B is Mg or Zn.

48. The scintillator material of claim 45, wherein X is Cl.

49. The scintillator material of claim 45, wherein the composition of Formula (V) is Cs₃MgCl₅.

50. A radiation detector comprising a scintillator material of claim 1 and a photon detector.

51. A method of detecting gamma rays, X-rays, cosmic rays, and/or particles having an energy of 1 keV or greater, the method comprising using the radiation detector of claim 50.

52. A method of preparing a scintillator material of claim 1, wherein the method comprises preparing the composition of one of Formulas (I), (II), (III), or (IV) via the vertical Bridgman technique.
